(19) United States
(12) Patent Application Publication
(10) Pub. No.: US 2006/0023676 A1
(43) Pub. Date: Feb. 2, 2006

(54) Port routing

(75) Inventors: David L. Whitmore, Coopersberg, PA (US); Christian E. Hofstaedter, Hellertown, PA (US); Christopher J. Bogdon, Cranberry Township, PA (US); William Doviak, Pottstown, PA (US); Flex Houvig, Wayne, PA (US)

Correspondence Address: GREENBLUM & BERNSTEIN, P.L.C., 1950 ROLAND CLARKE PLACE, RESTON, VA, 20191, US

(73) Assignee: PADCOM, Inc., Bethlehem, PA (US)

(21) Appl. No.: 11/107,815

(22) Filed: Apr. 18, 2005

Related U.S. Application Data
(62) Division of application No. 10/084,049, filed on Feb. 28, 2002, now abandoned.
Application No. 10/084,049 is a continuation-in-part of application No. 09/652,009, filed on Aug. 31, 2000, now abandoned.
Application No. 10/084,049 is a continuation-in-part of application No. 08/932,532, filed on Sep. 17, 1997, now Pat. No. 6,418,324.
Application No. 08/932,532 is a continuation-in-part of application No. 08/456,860, filed on Jun. 1, 1995, now Pat. No. 5,717,737.

(51) Int. Cl. H04Q 7/00; H04Q 7/24

(52) U.S. Cl. 370/338; 370/329

(57) ABSTRACT

A method routes data over multiple routes, including wireless networks, the data being received from multiple applications. The method includes ascertaining availability of the multiple routes, receiving data from a selected application of the applications, determining a designated route that is associated with the selected application, and sending the received data over the designated route when the designated route has been ascertained to be available. Moreover, a system routes data over multiple wireless networks. The data is sent from multiple applications each having a unique source port number. The system includes a mobile router that receives data from a selected a mobile router that receives data from a selected application. The mobile router includes a port routing table containing information that specifies, based on one or more characteristics of the data, over which wireless network the data should be routed. The characteristics of the data include a port number, IP address or protocol.

### CROSS REFERENCE TO RELATED APPLICATIONS

The present application is a divisional application of U.S. patent application Ser. No. 10/084,049, filed on Feb. 28, 2002, entitled Port Routing Functionality,” which is a Continuation-In-Part of U.S. patent application Ser. No. 09/652,009, filed on Aug. 31, 2000, entitled “Method and Apparatus for Routing Data Over Multiple Wireless Networks”, and which is also a Continuation-In-Part of U.S. patent application Ser. No. 08/932,532, filed on Sep. 17, 1997, entitled “Apparatus and Method for Intelligent Routing of Data between a Remote Device and a Host System,” now U.S. Pat. No. 6,418,324 issued on Jul. 9, 2002, which is a continuation-in-part of U.S. application Ser. No. 08/456,860, filed Jun. 1, 1995, now U.S. Pat. No. 5,717,737, issued on Apr. 14, 1997, entitled “Apparatus and Method for Transparent Wireless Communication Between a Remote Device and a Host System,” the contents of which are expressly incorporated by reference herein in their entirety.

The present application is related to U.S. Pat. No. 6,198,920, filed on Mar. 16, 2000, entitled “Apparatus and Method for Intelligent Routing of Data Between a Remote Device and a Host System,” and U.S. Pat. No. 6,826,405, filed on Jun. 10, 2002, entitled “Apparatus and Method for Intelligent Routing of Data Between a Remote Device and a Host System,” both of which are continuations of U.S. patent application Ser. No. 08/932,532, filed on Sep. 17, 1997, entitled “Apparatus and Method for Intelligent Routing of Data between a Remote Device and a Host System,” now U.S. Pat. No. 6,418,324, which is a continuation-in-part of U.S. application Ser. No. 08/456,860, filed Jun. 1, 1995, now U.S. Pat. No. 5,717,737, issued oil Apr. 14, 1997, entitled “Apparatus and Method for Transparent Wireless Communication Between a Remote Device and a Host System,” the contents of which are expressly incorporated by reference herein in their entireties.

### BACKGROUND OF THE INVENTION

1. Field of the Invention

The present invention relates to the field of wireless communications in general, and more specifically to communications over multiple wireless networks. In particular, the present invention relates to port routing that provides system administrators of wireless networks with flexibility to designate more specific routing behavior over multiple wireless networks for their applications.

2. Background Information

Currently, the wireless mobile routing system disclosed in U.S. patent application Ser. No. 09/652,009, relies on the concept of a single “default route” associated with each mobile client and host network server. This default route is derived through a combination of network priority and network availability. The highest priority, available network becomes the transport network over which all communications are routed through to the host network server.

The aforementioned system was not designed so that the host network server knows the status of other non-default networks for each mobile router. In other words, the host network server only knows the status of the current default network. As a result, the system administrator's ability to specify the behavior of routing for applications is minimal.

There currently exists a need to provide a wireless mobile routing system with greater flexibility or granularity in the ability to specify Internet protocol (IP) routing behavior. One method to enhance the IP routing flexibility or granularity of the aforementioned wireless mobile routing system is through a concept called port routing.

The function of IP ports is an important part of IP communications. It is well understood that each computer on an IP network will have a unique IP address. Therefore, when one computer needs to send data to another computer, it will address the other computer using the other computer's IP address. Data is not sent between computers, however; data is sent between programs running on those computers. Because computers run multiple programs simultaneously, and those programs may all be communicating over the network, how does the computer determine which data is for which program? The answer is IP ports.

The founding committee for the Internet specified that each application on a computer must send and receive data through a unique port number. In most cases, any time data is sent or received by a computer it will use both the sending and receiving IP address as well as the sending and receiving IP port number. As a result, whenever data is received at a computer, the computer knows which application is supposed to receive the data by looking at the destination port number on the actual packet.

Most standard applications have registered their ports with the Internet Assigned Number Authority (http://www.iana.org/). A sample of those applications with port numbers include: web browsing, port 80; secure web browsing, port 8080; TELNET, port 23; etc. It is an important fact to note that every application that sends and receives data does so on a unique port number. No two applications share the same port number.

The relationship between ports and IP addresses is similar to the relationship between post offices and post office boxes. A United States post office contains many post office boxes. When mail is sent, it is not enough to specify the post office's zip code; the post office box must also be specified. Similarly, when an application wants to send a data packet to another application, it is not enough to merely specify the IP address; the application must also specify the port.

Port numbers are used in a variety of networking applications such as firewalls or proxy servers. If a system administrator wishes to restrict access to a certain application, then the system administrator will do so by restricting certain port numbers from being sent through a firewall. However, port numbers have not been used when selecting appropriate wireless networks for transmission.

Thus, it would be desirable to provide system administrators of the wireless mobile routing systems with the ability to specify port routing at a granularity that includes at least the protocol, IP address, port number, and the specific network over which any packet matching the IP address, protocol and port number should be routed.

### SUMMARY OF THE INVENTION

In view of the foregoing, the present invention enhances the route registration functionality of the wireless mobile routing system disclosed in U.S. patent application Ser. No. 09/652,009, filed Aug. 31, 2000. The present invention, which may be embodied as mobile routing software, hardware, or a combination thereof, allows the host network server to be aware of the availability of all the networks connected to each wireless client having mobile router functionality. Moreover, the host network server will now know when the mobile router has shut down and no networks are available. Furthermore, the network server will better be able to track the status of each wireless client and each wireless network.

With port routing, the mobile router will not only simply notify the host network server of changes to the default network, the mobile router will also notify the host network server whenever any network becomes available (or unavailable). This will allow both the host network server and the mobile router to route packets over alternate, non-default networks as appropriate. The mobile routers will also be able to continue to route packets over the default network when appropriate.

An example use of port routing includes a configuration that allows e-mail applications to communicate only when a spread spectrum network is in coverage, while disallowing any use of web browsers over any network, and allowing all computer aided design (CAD) system traffic to flow over any network.

An embodiment of the present invention provides a port routing table that includes five types of fields. The port routing table may be actually located on both the Host Network Server and the Mobile Router. This allows for the fact that bidirectional communications can occur (i.e., the host can send packets to mobile routers or the mobile routers can send packets inbound to the hosts.) The fields enable an administrator to define the criteria to match different types of packets that flow through the mobile router, as well as the action that the mobile router should take with those packets. The five types of fields are:

The Type field identifies the type of route entry. In one embodiment, it contains either an “Ignore”, “Alternate” or “Default” keyword. This field indicates the action the mobile router should take for the designated packet.

The IP Address field specifies the IP address of the packet received from the route server. It can represent “All” IP addresses, or a specific IP address. If a specific IP address is entered, the user has the choice of specifying if the IP address appears in either the source or the destination address fields within the IP header.

The Protocol Type field identifies what type of transport level protocol the packet is. The values for this field will currently be only TCP, UDP or either. Of course, as additional protocols are employed, the additional protocols can be entered into the Protocol Type field.

The Port Number field identifies the port number of the packet received from the route server. Ports are associated with individual IP applications. The user can specify all ports, or may specify an individual port. The user also has the choice of specifying if the port number appears in the source or destination location in the TCP or UDP header.

The Network ID field is used in conjunction with the Type field. If the user created an “Alternate” entry as specified by the Type field, then the Network ID field will identify which network will be used to route the packets that match the specified criteria.

By taking advantage of the above fields, the administrator has the flexibility to specify that certain applications will use the default routing, certain applications will only function over specified alternate networks, and certain applications will not have their data routed.

According to an aspect of the present invention, a method is provided for routing data over multiple routes, including wireless networks. The data is received from multiple applications The method includes ascertaining availability of the multiple routes, receiving data from a selected application of the multiple applications, determining a designated route that is associated with the selected application, and sending the received data over the designated route when the designated route has been ascertained to be available.

According to another aspect of the present invention, determining further includes determining the designated route based upon one or more port numbers assigned to the selected application. In yet another aspect of the present invention, determining further includes determining the designated route based upon one or more IP addresses associated with the selected application. In another aspect of the present invention, determining further includes determining the designated route based upon one or more protocols of the data received from the selected application.

According to a further aspect of the present invention the designated route indicates that the data is to be ignored. In this case the sending includes not sending the data. In another aspect of the present invention, the designated route includes a default route. According to still a further aspect of the present invention, the designated route includes an alternate route.

Other aspects of the present invention include wherein the determining further includes determining the designated route based upon a port number associated with a destination of a received packet. Further aspects of the invention include wherein the determining further includes determining the designated route based upon an IP address associated with a destination of a received packet. According to another aspect of the present invention, the ascertaining further includes notifying a host network server of the availability of each route when a route is ascertained to be available.

Another aspect of the present invention includes a system for routing data over multiple wireless networks. The system includes a mobile router that receives data from a selected applications. The mobile router includes a port routing table containing information that specifies, based one or more characteristics of the data, over which wireless network the data should be routed. The characteristics include a port number, IP address and/or protocol.

Additionally, other aspects of the present invention include an alternate route over which the data is routed is specified based upon the at least one characteristic of data. In yet another aspect of the invention, a default route over which the data is routed is specified based upon one or more characteristics of data. In another aspect of the present invention, an ignore route is specified based upon the data characteristics.

According to a further aspect of the present invention, the information in the port routing table is configured from the host network server and pushed to the port routing table in the mobile router. In another aspect of the present invention, the mobile router notifies the host network server whenever any wireless network enters an in-coverage state.

In yet another aspect of the present invention, a system is provided for routing data over multiple wireless networks. The data is sent from multiple applications. The system includes a host network server that receives data from a selected application. The host network server contains a port routing table having information that specifies, based on one or more characteristics of the data, over which wireless network the data should be routed. The characteristics include a port number, IP address and/or protocol.

Another aspect of the present invention provides, a computer readable medium storing a computer program is provided that enables the specification of IP routing behavior over multiple wireless networks. The computer readable medium includes a source code segment that receives data from multiple applications. Each application has a unique port number. The medium also includes a source code segment that stores a port routing table containing information that specifies, based on an application's port number, IP address and/or protocol, over which wireless network the application's data should be routed. The table also contains information on whether the application's data should not be routed over the multiple wireless networks. The medium further includes a source code segment that determines from the information contained in the port routing table an appropriate wireless network for the data from the applications to be routed over.

According to a still further aspect of the present invention, the port routing table includes a port route type indicator field, IP address field, protocol type field, port number field, and/or network ID field. Other aspects of the present invention include wherein the port route type indicator includes alternate, ignore, and/or default indicators. Further aspects of the present invention include when the alternate indicator is selected, data will be routed through a specified alternate wireless network. According to other aspects of the present invention, when the ignore port route type indicator is selected, data will be ignored instead of being routed.

Moreover, according to other aspects of the present invention, when the default port route type indicator is selected, data will be routed through a default network. According to another aspect of the present invention, the port routing table further includes a field to indicate whether an IP address appears in a source, destination, or either location within a protocol header of data packets being transmitted. According to a further aspect of the present invention, the protocol type field identifies the transport level protocol type of tile packet. According to a still further aspect of the invention, the port number field identifies the port number of an application.

Additionally, other aspects of the present invention includes the port routing table further including a field to indicate whether a port number appears in a source, destination, or either location within a protocol header of data packets being transmitted. In yet another aspect of tile present invention, the network ID field identifies which network is used to route data. In another aspect of the present invention further includes an availability source code segment that ascertains the availability of the multiple wireless networks. And according to still a further aspect, the present invention further comprises a sending source code segment that sends tile received data over the appropriate wireless network when the routing path has been ascertained to be available.

Other exemplary embodiments and advantages of the present invention may be ascertained by reviewing the present disclosure and tile accompanying drawing.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 is diagram of a wireless mobile routing system that includes a host network server, multiple wireless networks, and multiple mobile routing devices;

FIG. 2 illustrates a general overview of the mobile client side of the wireless mobile routing system that includes a mobile router;

FIG. 3 illustrates a software architecture for a host network server;

FIG. 4 is a flow chart showing an exemplary process executed by the host network server for processing incoming data received on a wireless network;

FIG. 5 shows an exemplary route table;

FIGS. 6, 7, and 8 are flow charts showing exemplary logic executed by the host network server for processing outgoing data;

FIG. 9 shows an exemplary software architecture for the mobile router in an initial state;

FIG. 10 shows an exemplary software architecture for the mobile router at a later state;

FIG. 11 shows an exemplary route registration packet;

FIG. 12 shows an exemplary graphical representation of port routing functionality, according to an aspect of the present invention;

FIG. 13 is an illustration of an exemplary port routing table having a variety of port routing configurations, according to an aspect of the present invention;

FIG. 14 is a flow diagram depicting an exemplary manner in which routes are registered, according to an aspect of the present invention;

FIGS. 15(a) and 15(b) are flow diagrams depicting an exemplary manner in which routes are looked up when port routing is enabled, according to an aspect of the present invention;

FIG. 16 is screen shot showing an exemplary port routing configuration screen in which the mobile administrator has added five specific routes, according to an aspect of the present invention;

FIG. 17 is a screen shot of an exemplary port routing configuration screen which allows editing of port routing entries, according to an aspect of the present invention;

FIGS. 18(a) and 18(b) are screen shots of exemplary route table displays, according to an aspect of the present invention;

FIG. 19 illustrates a general overview of another embodiment of the present invention which includes a mobile router in accordance with an aspect of the present invention;

FIG. 20 illustrates a schematic block diagram of the mobile router in accordance with an aspect of the present invention;

FIG. 21 is an illustration of a block diagram of the functional components of the router in accordance with an aspect of the present invention;

FIG. 22 is an illustration of a block diagram of the switch within the router according to the present invention;

FIG. 23 is an illustration of a flow chart of the processing steps used by the router to initialize and build tables stored in the Router in accordance with an aspect of the present invention;

FIG. 24 is a flow chart of the processing steps used by the router for checking availability of each network interface in accordance with an aspect of the present invention;

FIG. 25 is a flow chart of the processing steps used by the router to account the availability of the channels and the user's configuration in order to decide which channel to use for transporting data in accordance with an aspect of the present invention;

FIG. 26 is a flow chart of the processing steps used by the router for an error handler in accordance with an aspect of the present invention; and

FIG. 27 is an illustration of the software architecture of the Router in accordance with an embodiment of the present invention.

### DETAILED DESCRIPTION

Wireless Mobile Routing System

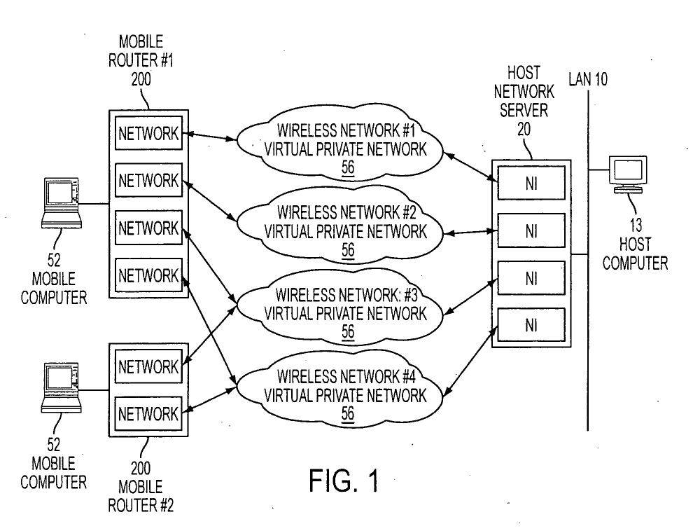

FIG. 1 shows an overall system diagram of an existing wireless mobile routing system which includes a Host Network Server 20 acting as an access point to a Local Area Network 10, multiple Mobile Routers 200, at least one host application 13 on the LAN 10, and multiple networks 56. Although FIG. 1 shows a host application 13 on the LAN 10, the wireless mobile routing system does not require a host application 13 on the LAN 10 because the wireless mobile routing system supports Mobile Router 200 to Mobile Router 200 communications.

The Mobile Router 200 can take many different forms. It can be created in hardware and can be physically separate from the mobile device 52. In another embodiment, the Mobile Router 200 can be completely developed in software and reside on the mobile device 52 in the device's operating system. In another embodiment, the mobile router can be created in silicon hardware and be present within the hardware of the mobile device 52.

With reference to FIG. 1, the mobile device 52 may comprise a software application running on a portable or laptop computer performing a variety of functions as programmed by the software application (e.g., database services). The mobile device 52 may be a special purpose device designed to perform a particular function, such as a credit card reader or barcode scanner. The mobile device 52 may generate a data stream that is sent to a fixed location (e.g., a host computer infrastructure 10).

An exemplary application running on the mobile device 52 is a mobile remote client application th at provides the remote user with the capability to send and retrieve data from a fixed database server application. The data may include of customer records which, for example, may be used by service personnel operating a fleet of vehicles to service customers scattered about a wide geographic area. In the exemplary application, the mobile client application may request customer records from the fixed database server, and display the records for viewing by mobile service personnel. The mobile client application may send updated records to the fixed database as the service personnel finish assigned tasks. The updated records may contain a service history, equipment upgrades, and repairs for each customer.

Another exemplary application running on the mobile device 52 may be a client application that retrieves a list of dispatched jobs to be performed by the service personnel during each day. The jobs may be uploaded to the remote mobile device 52 each morning and stored in another client application in the mobile device 52. As the service personnel change job locations, the status of each job may be updated to indicate a status, e.g., en route, arrived and finished with comments. The status may be sent from the application to the fixed home office, so a dispatcher at the home office is aware of the locations of service personnel in the field.

By way of non-limiting examples, the mobile device 52 may comprise a portable or laptop computer; a computer having an embedded Router 200; a terminal or terminal emulator; a data gathering device (e.g., a SCADA system or remote telemetry system for obtaining data from a remote location for forwarding to a central location for processing); a card-swipe reader device (e.g., credit/debit/bank cards) for use in a mobile billing application, such as a taxi or mobile food cart; a smart-card reader; a logging device, such as those used in a package delivery system or fleet; a device for reading bar codes (e.g., for inventory control); and a remote application with data to send or to receive, from a fixed device (e.g., remote diagnostic tool). The above-noted applications are provided merely for exemplary purpose, and other applications and mobile devices 52 may be used with Router 200.

As seen in FIG. 1, a one to many Virtual Private Network (VPN) is created between the one Host Network Server 20 and multiple Mobile Routers 200. The Host Network Server 20 is connected to each Mobile Router device 200 by multiple networks 56. Data can be sent to each Mobile Router 200 without requiring the host application 13 residing on the LAN 10, or another mobile device 52, to select a network for transmission. That is, the host application 13 or other mobile device 52 can send data to a desired mobile device 52 without concerning itself with the network 56 that will actually transmit the data.

In one embodiment, data sent outbound from Host Network Server 20 is tunneled via an appropriate network 56 to the mobile device 52. Tunneling is defined as adding a header to a data packet in order to send the data packet between two locations while hiding the contents of the packet from other locations. The tunneling capability has long been used to bridge portions of networks that have disjoint capabilities or policies. As a result of this VPN, the end point IP addresses and devices are effectively hidden from any of the other network devices within the particular network. This VPN also supports both compression and encryption.

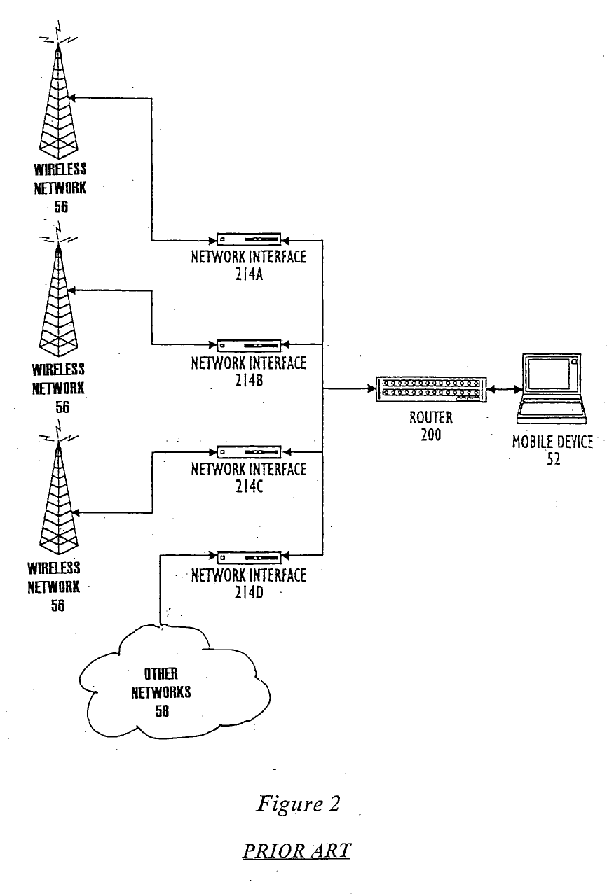

Referring now to FIG. 2, therein is illustrated a general overview of the client side of the wireless mobile routing system which includes a Mobile Router 200. The Router 200 provides the mobile device 52 with the capability to selectively transmit and receive data over multiple wireless infrastructures 56 and/or other networks 58 in accordance with user configured parameters.

Typically the mobile device 52 sends and receives data using a variety of protocols (e.g., Internet Protocol (IP)/transparent (via MDC 54)/ack-nack, etc.). The use of a variety of protocols provides for open transport of data throughout many networks, and in particular, networks which support open standards such as IP. However, many proprietary networks which require interface and/or protocol translation remain in use. In the Router 200 of the present embodiment, the function of interfacing with networks and protocol translation may be performed by the Network Interfaces 214A-D.

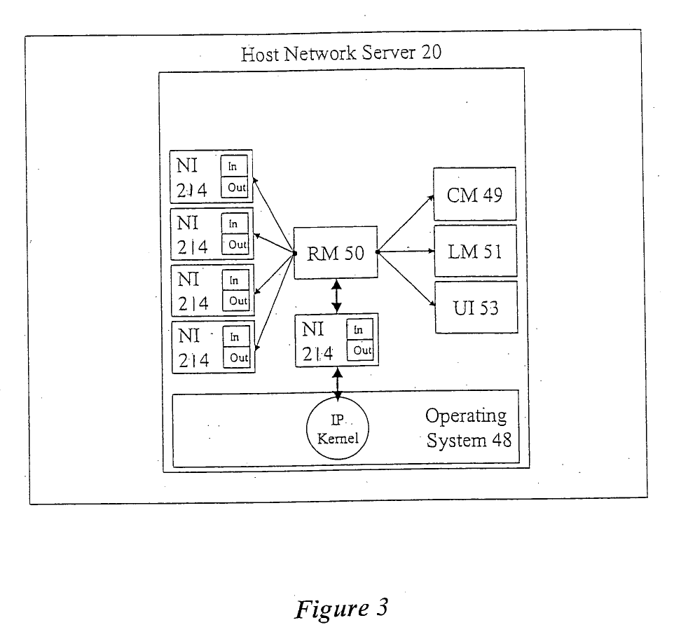

FIG. 3, shows an exemplary software architecture of the Host Network Server 20 at an initial state. The Host Network Server 20 runs on any operating system 48. An exemplary operating system is Microsoft Windows NT. The Host Network Server 20 contains several different processes, in addition to the operating system 48. A Configuration Manager (CM) 49 manages all the configuration parameters required for the Host Network Server 20. A Logging Manager (LM) 51 is responsible for managing any log messages generated from the modules. The Router Manager (RM) 50 is responsible for routing from source network interfaces to destination network interfaces 214. The Network Interfaces (NI) 214 are responsible for interfacing to each of the wireless networks 56. The Network Interface 214 is also responsible for converting the data from IP to the format required by the wireless networks 56. A user interface (UI) 53 provides an administrator with functions to control and administer the Host Network Server 20 including viewing the diagnostic logging information.

Upon startup of the Host Network Server 20, the Router Manager 50, Configuration Manager 49, and Logging Manager 51 processes begin. The Configuration Manager 49 is responsible for reading in configuration parameters from persistent storage. This configuration information specifies which Network Interfaces 214 should start. Such configuration information is determined by a system administrator. The configuration information specifies configuration options for all subsystems present in the system. Such configuration options for Network Interfaces 214 may include, for example, a network address for non-IP networks (e.g., a telephone number for a circuit switched cellular connection; or a modem serial number, a baud rate and serial port for a serial port connection) or an IP address for IP networks.

Once the Router Manager 50 begins, it attaches itself, through a Network Interface 214, to the IP stack of the operating system 48 and registers a local IP address specified in the configuration. By connecting to the IP stack, the Host Network Server 20 is permitted to send and receive IP datagrams directly to the IP stack. If the Host Network Server 20 is unable to bind this connection, the Host Network Server 20 displays a notification that routing to and from the LAN 10 is disabled. In this case, however, mobile users can still communicate to other mobile users. Assuming the Host Network Server 20 binds correctly, the Host Network Server 20 provides routing functionality and is responsible for sending data to the LAN 10 and receiving data from the LAN 10. The Router Manager 50 then starts the Network Interfaces 214 specified in the Configuration Manager 49.

Each Network Interface 214 is associated with a specific wireless network 56 and is responsible for sending and receiving data to and from the wireless network 56. Each wireless network 56 will require some type of transceiver to communicate with the wireless network 56. An exemplary list of wireless network 56 transceivers includes private voice radio using e.g., the MDC 54 and a variety of radios, both conventional and trunked; Cellular Digital Packet Data (CDPD), such as Sierra Wireless or NovaTel CDPD modems; spread spectrum, either direct sequence, or channel-hop, as Xetron Hummingbird spread spectrum modem; GSM, such as Ericsson serial GSM module; RDI (e.g., Ericsson) interface, implemented via a software protocol module and quasi-RS232 interface to radio; AMPS; Mobitex; DataTac, both public and private, Ethernet; Ardis; PCS; and any other network which is either transparent or operates using a specific protocol. The Network Interface 214 can connect to the wireless transceiver, which in turn allows communication through the wireless network. The Network Interface 214 can connect to the transceiver via many methods, including but not limited to: IP, X.25, a local modem connection, local serial port connection, USB, Ethernet, wirelessly, RS485 and any other connection medium which is either transparent or operates using a specific protocol.

Upon startup of the Network Interface 214, the module verifies its own configuration received from the Configuration Manager 50. If the configuration is invalid, the process displays an error message and may be unavailable for routing. If the configuration is successful and the required parameters are set correctly, the process starts its own initialization routine.

The type of network connection available determines the types of initialization that occurs. For example, in the case of a pure IP connection (i.e., a connection to an IP network), the Network Interface 214 opens a socket to connect to the IP address of the remote device. In the case of a serial connection to the network, the process opens the serial port and sets up the serial line parameters. If at any time the connection cannot be made, the process logs a message to the Logging Manager 52 and will be made unavailable for use. Once the Network Interface 214 completes its initialization, it starts its inbound and outbound threads to monitor the wireless networks 56 for sending and receiving data. After the inbound and outbound threads are started and the Network Interfaces 214 can successfully communicate to the network, the process threads wait for data on each of the networks 56.

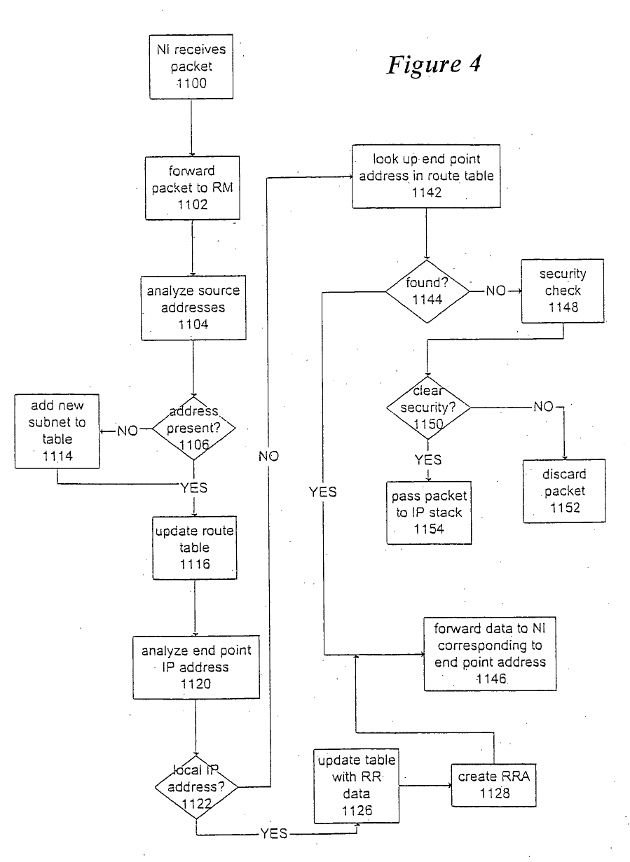

Processing of an inbound packet received from one of the wireless networks 56 is now described with reference to FIG. 4. If an inbound packet has been detected at one of the Network Interfaces 214, the Network Interface 214 receives the data from the network in the network's format at step 1100. Any framing and or error checking/correction required by the network will be performed to ensure the integrity of the data. The Network Interface 214 acknowledges (ACK) the wireless network provider if the provider requires it or provides a negative acknowledgment (NAK), if appropriate.

The Network interface 4 then saves the source hardware addresses (e.g., modem serial number) of the inbound packet, if the wireless network 56 is a non-IP network. As an example, in the case of a circuit switched cellular connection, the hardware address would be a telephone number. If the wireless network 56 is an IP network, no hardware addresses are saved at this time because the packet itself includes the source and end point IP addresses. (In this document, the IP address of the mobile router will also be referred to as the end point IP address. It identifies the address of the router, not the address assigned by the wireless network, which will be referred to as the gateway address.) At this point, the Network Interface 214 strips off any headers or trailers placed around the received data by the network provider. The remaining data is the original data sent by the original mobile routing device 200.

The Network Interface 214 then creates an interprocess communication (IPC) packet that includes at a minimum, the original data, the length of the packet, the source network ID as well as the source and end point hardware addresses of the packet when the wireless network 56 is not an IP network. This packet is then sent to the Router Manager 50 process via the standard IPC mechanisms, at step 1102.

Once the Router Manager 50 receives the data from the interprocess communication (IPC) mechanism, the Router Manager 50 determines which interface sent the packet based upon a source network ID included in the IPC packet associated with the received data. The Router Manager 50 then validates the IP packet checksum. If the checksum fails, the packet is silently discarded. Otherwise, the received packet is verified as an IP version 4 packet. This information is readily available in the IP header If the packet does not meet the version 4 criteria, then it is silently discarded. The source IP address of the received packet (depending on the originating network) is then analyzed at step 1104. More specifically, at step 1106 the Router Manager 50 determines if the source IP address is present in a route table stored in persistent storage. In other words, the subnet on which the source IP address resides is looked up.

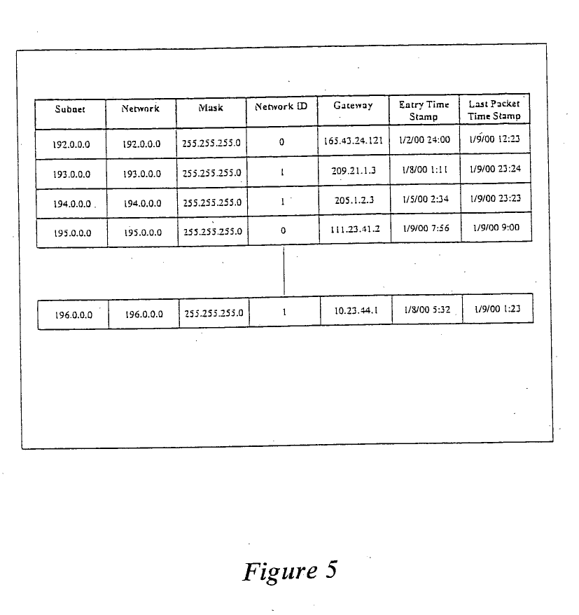

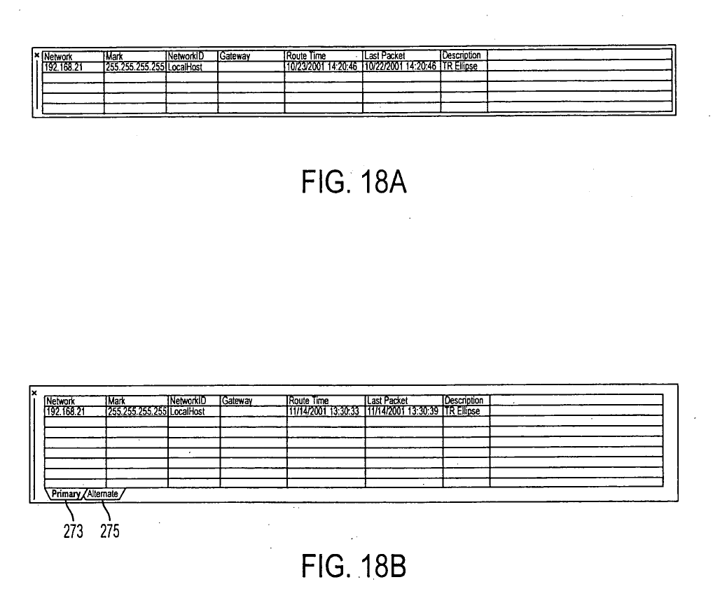

An exemplary route table is shown in FIG. 5. Furthermore, FIGS. 18(a) and 18(b) also show an example for presenting the route table to the user in a user readable format. The figures show an example of how the display of the route table can be shown to the user within a graphical user interface. If the IP address is present, the Router Manager 50 updates the route table to reflect that a packet has been received from the wireless network 56 (e.g., with a time stamp) at step 1116. Any route entry in the route table indicates that the associated route actively connects to the Mobile Router 200. Otherwise, at step 1114 the new subnet is added to the route table and the route table is updated at step 1116. However, certain subnets can be ignored, for example, when packets are received from broadcast addresses, the addresses are excluded. That is, the subnets corresponding to those addresses are not input into the route table.

The route table includes three fields that correlate to the end point address: the Subnet field, the Network field, and the Mask field. As is well known, the subnet value is calculated from a bitwise AND operation of the mask value and the network value. The mask and network values are learned in a well-known way. Each end point address can then be classified into a subnet in a well known manner. Consequently, based upon the subnet in which the end point address is classified, a gateway address can be determined by examining the value in the Gateway Address field. The Network ID field stores arbitrary values corresponding to each Network Interface 214. Thus, by using the network ID value, the Host Network Server 20 knows which Network Interface 214 should be employed to communicate with the gateway address. The Entry Time Stamp field stores a time stamp entry indicating when an entry is first stored in the route table. The Last Packet field stores a value indicating the time when the last packet was received from the corresponding gateway address.

The module 50 will then decrement the Time to Live (TTL) parameter in the IP header. If the TTL parameter is zero, then the packet is discarded and a Time to Live discarded message is sent back to the originator of the packet. At this point, it is logged into the database. The Router Manager 50 then analyzes the end point IP address at step 1120. At step 1122, the Router Manager 50 determines if the end point IP address of the packet matches its own local IP address. If these addresses match, the packet is for the local Router Manager 50. There can be several different types of packets that the Router Manager 50 can receive. One example includes a route registration (RR) packet. The Router Manager 50 updates the routing table with all of the addresses listed in the RR packet at step 1126, as well as the gateway address which the packet came in from. The Router Manager 50 process then creates a route registration acknowledgment (RRA) packet at step 1128 for forwarding back to the mobile router 200. Consequently, the Router Manager 50 passes the data to the appropriate Network Interface 214 corresponding to that mobile router 200 at step 1146.

If it is determined at step 1122 that the packet's end point address is not coincident with the Host Network Server's local IP address, the Router Manager 50 looks up the received end point address in the route table at step 1142. If the address is found in the local route table (step 1144:YES), the Network Interface 214 corresponding to that end point address is noted. The end point address can be another mobile routing device 200 or a host 13 on the LAN 10.

If it is determined that the packet is not in the route table at step 1144, then a destination unreachable message is sent to the originator of the packet. In one embodiment, all mobile users by default have the authority to send packets to any IP address and port combination on the LAN 10. In another embodiment, if the administrator wants to create a more secure network, the administrator creates a security database including all IP address/hardware address combinations to which each mobile device is authorized to communicate.

In this embodiment, the Host Network Server 20 checks the packet against its own security database at step 1148. More specifically, the Host Network Server 20 looks up the end point IP address and the destination port number in the security database. If an entry exists for the source address and end point address combination (step 1150:YES), the Router Manager 50 forwards the packet to the appropriate Network Interface 214 specified in step 1144 for eventual delivery to the end point address at step 1154. If the address does not exist in the table (step 1150:NO), a log message is created and the packet is silently discarded at step 1152.

This firewall functionality provides the additional benefit of preventing selected remote devices from accessing selected destinations. For example, an administrator may not want all mobile users browsing the company's intranet server via the wireless network. It is noted that all IP packets are verified against the security database in this embodiment.

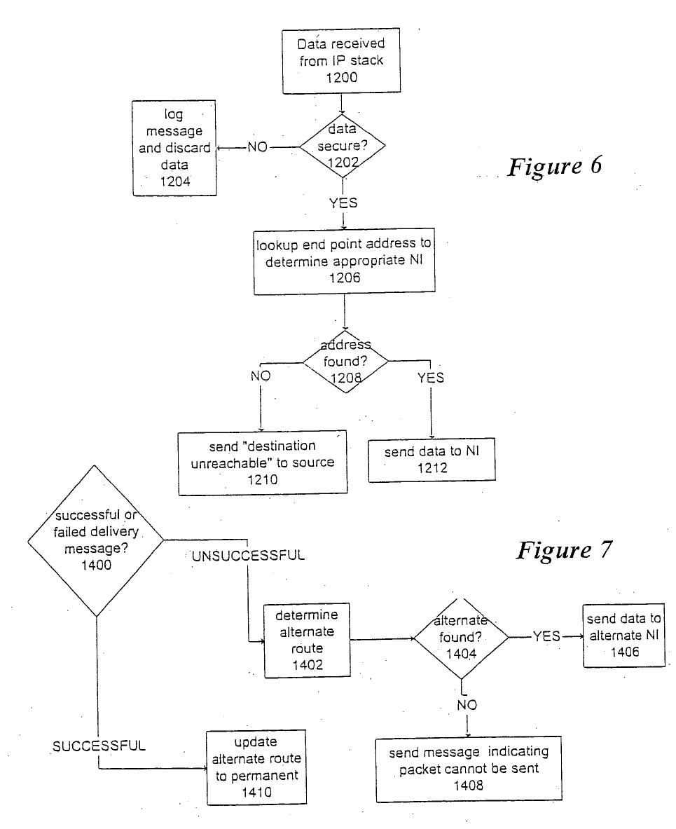

Processing of data received from the LAN 10 is now discussed with reference to FIG. 6. Data received from the LAN 10 in this scenario is outgoing data received from a host application 13 intended for a mobile router 200. If any data is received at the LAN 10 via a network adapter, the Router Manager 50 process receives the data at step 1200. The Router Manager 50 first validates the IP packet checksum. If the checksum fails, the packet is silently discarded. Otherwise, the received packet is verified that it is an IP version 4 packet. This information is readily available in the IP header. If the packet does not meet the version 4 criteria, then it is silently discarded. The module will then decrement the Time to Live parameter in the IP header. If the TTL parameter is zero, then the packet is discarded and a Time to Live discarded message is sent back to the originator of the packet.

The data packet is then scanned against the security database at step 1202. If the source address and end point address combination do not exist in the database, a message is logged and the packet is silently discarded at step 1204. Provided that the packet has passed the internal security checks, the end point address of the IP packet is looked up in the route table at step 1206. If the address is not found in the route table (step 1208:NO), the Router Manager 50 sends a destination unreachable message back to the original source address at step 1210. If a matching entry is found in the route table (step 1208:YES), the Router Manager 50 creates an IPC packet containing the original data, the message length, and the end point IP address (when an IP network) or end point hardware address (when not an IP network). The Router Manager 50 then sends the message to the Network Interface 214 process via the IPC channel at step 1212.

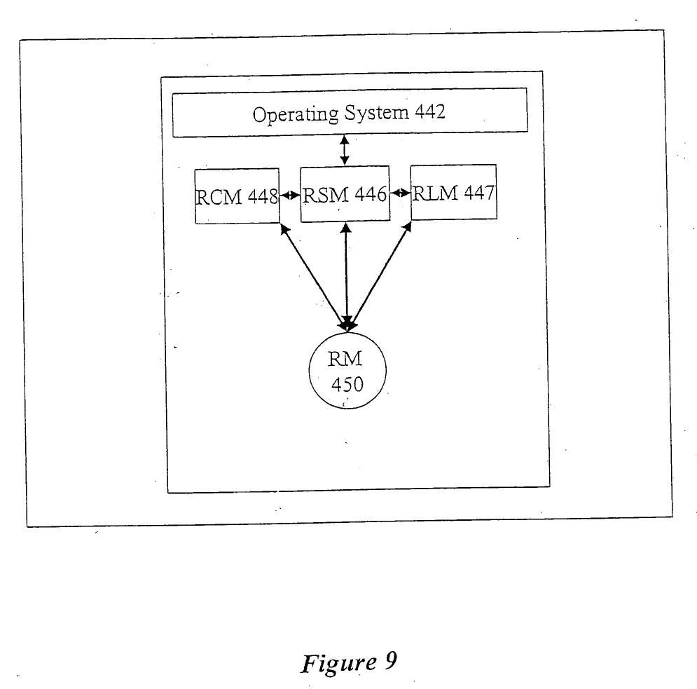

FIG. 8 illustrates the logic executed by the Network Interface 214 upon receiving the message from the Router Manager 50 Once the Network Interface 214 receives the data from the IPC channel at step 1300, it creates a data packet for the wireless network 56 at step 1302. The end point address of the packet sent from the LAN 10 was provided in the IPC message. At step 1304 it is determined whether the network is an IP network. If the network is an IP network, then a tunneled packet must be created. The source IP address of the packet is set to the local Network Interface 214 IP address and the end point IP address is set to a gateway address of the mobile routing device provided in the IPC message at step 1306. Gateway addresses are IP addresses corresponding to the wireless network 56, assigned by the wireless network provider. If the network is a non-IP network, the source address of the packet native to the non-IP format is set to the local Network Interface 214 hardware address at step 1308. The end point hardware address is the remote device's hardware address. Once the data packet has been created, at step 1310 it is sent to the wireless network provider using the format required by the wireless network provider for delivery to the mobile user. In certain networks, the modem is not always connected to the network (e.g., circuit switched cellular network). Therefore, before a packet is transmitted, some connection means must be initiated. It is the function of the Network Interface 214 to initiate this connection if it is required.

At step 1312 it is determined whether the packet has been successfully delivered. If for some reason, the Network Interface 214 cannot deliver the packet successfully to the mobile router 200, the Network Interface 214 sends a message back to the Router Manager 50 process to alert the Router Manager 50 that the Network Interface 214 was unable to successfully deliver the packet at step 1314. The Router Manager 50 decides to use a different route to the mobile destination, if one exists, when delivery was unsuccessful.

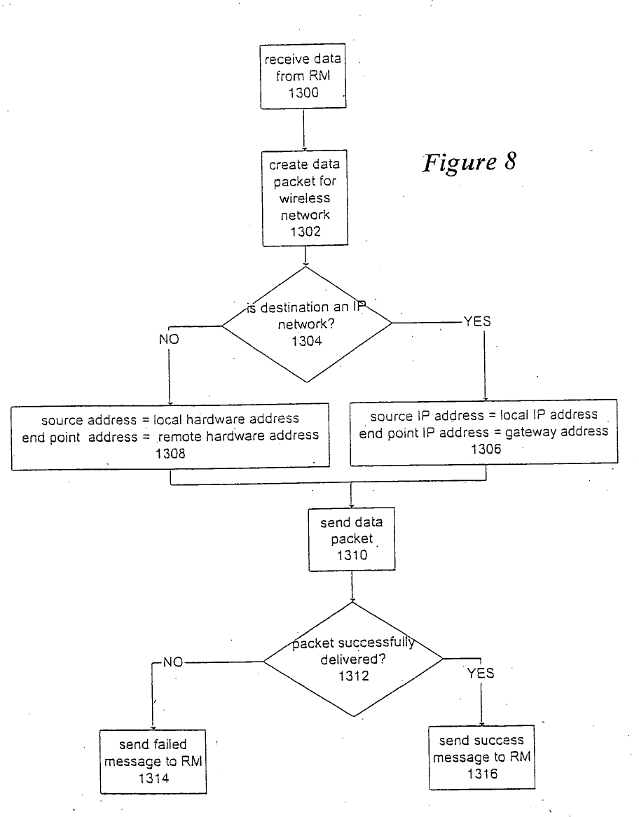

With reference to FIG. 7, the Router Manager's logic for determining an alternate route is discussed. At step 1400 the Router Manager 50 determines whether the message received from the Network Interface 214 indicates unsuccessful delivery. If the message indicates that delivery was not successful, the Router Manager 50 then scans its internal configurations, at step 1402, to determine an alternate route. If an alternate route is found (step 1404:YES), the Router Manager 50 forwards the data packet to the Network Interface 214 corresponding to this new route at step 1406. The logic described with reference to FIG. 8 then repeats and the Router Manager 50 awaits a message indicating whether the transfer was successful.

If the Network Interface 214 was successful in delivering the packet, the Router Manager 50 receives a message from the Network Interface 214 indicating that the route was successful (step 1400:SUCCESSFUL) Consequently, the Router Manager 50 makes the route permanent at step 1410. If all the routes have been tried and the packet cannot be successfully delivered (step 1404:NO), then a destination unreachable message is sent back to the source of the packet at step 1408.

The Host Network Server 20 also provides the administrator with statistical information regarding data that passed through the system. Any event that occurs will increment a counter on a user-by-user basis. These statistics can be presented to the user in many different formats. The statistics can be useful for administrators to pinpoint problems with certain mobile devices, comparing bills from the service provider to actual usage, etc.

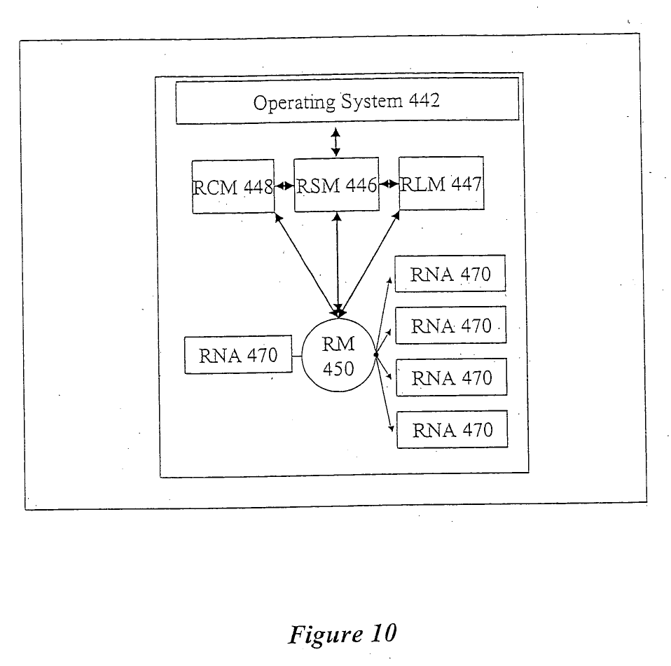

FIG. 9 shows a software architecture that permits a mobile device 52 to communicate with a Host Network Server 20 on a Local Area Network 10. The software may reside on each mobile device 52 eliminating the need for the Mobile Router 200, or in an alternate embodiment, the software may reside on the Router 200, which is physically separate from the mobile device 52. The software may also be provided as hardware or a combination of software and hardware.

The operating system 442 is the mobile device's operating system when the mobile device 52 executes the routing software of the present invention. If a separate router 200 is provided, the operating system 442 runs on the Mobile Router 200. Any type of operating system 442 can be used to run the software. Exemplary operating systems include C Executive, available from JMI Software Systems, Inc., and Microsoft Windows CE, 95, 98, NT or 2000, available from Microsoft Corporation.

As a non-limiting exemplary hardware implementation, the Mobile Router 200 may include an 80386EX microprocessor, running at 33 MHZ, 256 kilobytes of FLASH ROM, 512 kilobytes of static RAM, six asynchronous serial ports, two TTL-to-RS232 converters interfacing with two of the six serial ports directly to compatible devices external to the Switch 212, and four internal TTL serial interfaces to internally-mounted daughter boards, which carry Network Interfaces 214A-D. Each Network Interface 214 mounted on a daughter board may include a power supply for the Network Interface, a serial interface to the 80386EX microprocessor, and an interface to the outside network. The outside network may be a radio, a LAN, an antenna (for internally-mounted radios in the Network Interface 214), or other device accepting or supplying data from/to the Router 200.

The routing software starts once the operating system 442 has started. More specifically, once the operating system 442 successfully starts, it initiates one asynchronous process, the Router System Module 446 (RSM). The Router System Module 446 (RSM) is responsible for launching the Router Configuration Module 448 (RCM), Router Logging Module (RLM) 447 and the Router Module 450 (RM).

The Router Configuration Module 448 (RCM) is responsible for reading configuration data for the interfaces to the wireless networks 56 (for output) and to the mobile device 52 (for input). The mobile device 52 (i.e., client) is envisioned to be any device that can receive and/or send data to the routing software (e.g., mobile computer, GPS Reader, Card Reader, etc.). The Router Module 450 is responsible for making routing decisions on the available networks, once all networks are initiated. The Router Logging Module is 447 responsible for capturing and saving any diagnostic log messages generated from the applications. If any of these processes fail to start, the user of the mobile device 52 is alerted by a suitable means supported by the operating system 442.

Any number of mobile devices 52 and output devices (e.g., transceivers such as modems interfacing with the wireless networks 56) can be used. The number is only limited by the availability of hardware interfaces to the devices (e.g., serial ports, USB ports, PC card slots, parallel ports, etc.). Common configurations include two mobile devices 52 (e.g., mobile computer and GPS transceiver) and one wireless network 56 (e.g., CDPD), one mobile device 52 (e.g., mobile computer) and two wireless networks 56 (e.g., CDPD and private RF), or two mobile devices 52 (i.e., mobile computer and GPS transceiver) and two wireless networks 56 (e.g., CDPD and private RF).

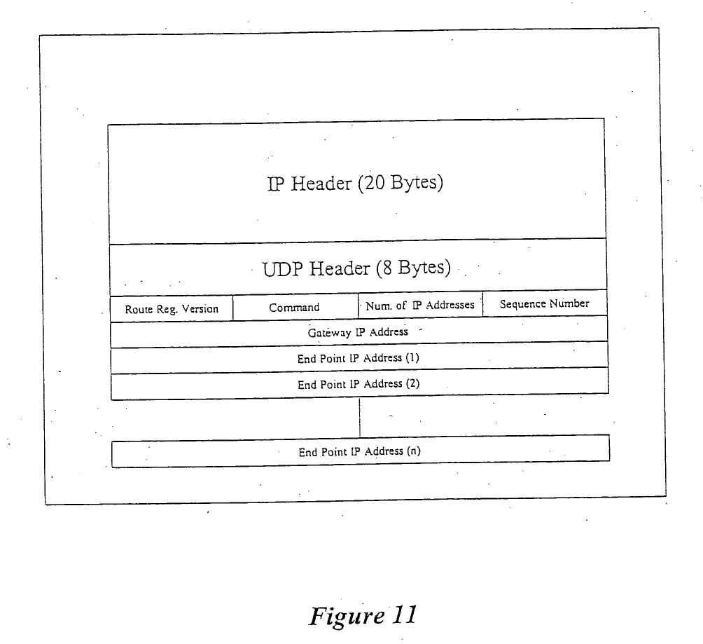

FIG. 10 shows the Router 200 after all appropriate processes have been launched. Two types of interfaces can be started and configured. The first type includes a standard Routing Network Adapter (RNA) 470 that is responsible for communicating to a communications device. This communications device can include a computer 52, or a network device such as a wireless modem. These processes manage the flow of data to and from the mobile routing device 200. The second type of interface is called the Auxiliary Feature Shell (AFS). The AFS processes can be a stand-alone application(s) developed to perform a specific function. The function does not have to involve routing of data or wireless networks. An exemplary AFS process provides store and forward functionality.

Each Router Network Adapter (RNA) 470 is responsible for dealing with network device specific behaviors. The Router Network Adapter 470 is responsible for the device specific functionality including device initialization, device termination, status checks, protocol conversion, packetization, etc.

A variety of messages can be sent from the Router Network Adapter 470 to the Router Module process 450 including at least a NetworkDown message and a NetworkUp message. The NetworkDown message informs the router that the wireless network 56 is not available for reasons such as hardware failure, out of wireless coverage, etc. The NetworkUp message alerts the Router Module 450 that the wireless network 56 is up and can be used for communications. All Router Network Adapters 470 initially start with the initial state of NetworkDown.

The Router Network Adapter 470 begins by initializing the assigned hardware device. Every device requires its own set of initialization functions. The Router Network Adapter 470 begins by opening up a hardware connection to the device. This connection can be, but is not limited to RS232, Universal Serial Bus (USB), Ethernet, Token Ring, IRDA, Parallel, Bluetooth, or any other communications port supported by the operating system 442. For most network devices, the Router Network Adapter 470 then performs initialization routines set by the device manufacturer and/or wireless network provider. Examples of these initialization routines include using AT commands, user defined protocols, etc. to start the device's communications link to the wireless network 56. If any of the initialization routines fail, the Router Module 450 is aware of the fact because the initial start state is NetworkDown. At this point, with no inbound or outbound data activity occurring, the Router Network Adapter 470 attempts to gather network status information from the hardware device.

Two methods for network status queries are used by modem manufacturers. In the first method, modems require the software to query the modem for its status, using some predefined set of commands. After the modem receives this status query, it queries the wireless network and returns the current status of the modem back to the software. For example, the modem can indicate that it is out of range. The drawback to this method of status query is that the software is tasked with querying the modem on a regular interval. This interval should be as short as possible, but not so short as to impact the normal data transfer functionality of the modem.

In the second method, modems provide unsolicited responses regarding network status. For example, the software receives status query responses without having to send the modem a command. Usually the modem responds by either sending back a status response packet or by changing the state of the hardware connection (e.g., RS232 DCD line). The advantage of transceivers using the second method of status reporting is that the switching to and from the network occurs instantly when the network status changes rather than waiting for the software to query the modem on a regular basis. Whenever the status of one of the hardware devices has changed from its previous state, the Router Network Adapter 470 sends a message to the Router Module 450 with the updated status.

Each Router Network Adapter 470 is configured with the gateway IP address from the configuration data block. This gateway IP address or hardware address is used to route packets through to get to the mobile device 52 or Host Network Server 20 and is referred to as the network's gateway IP Address.

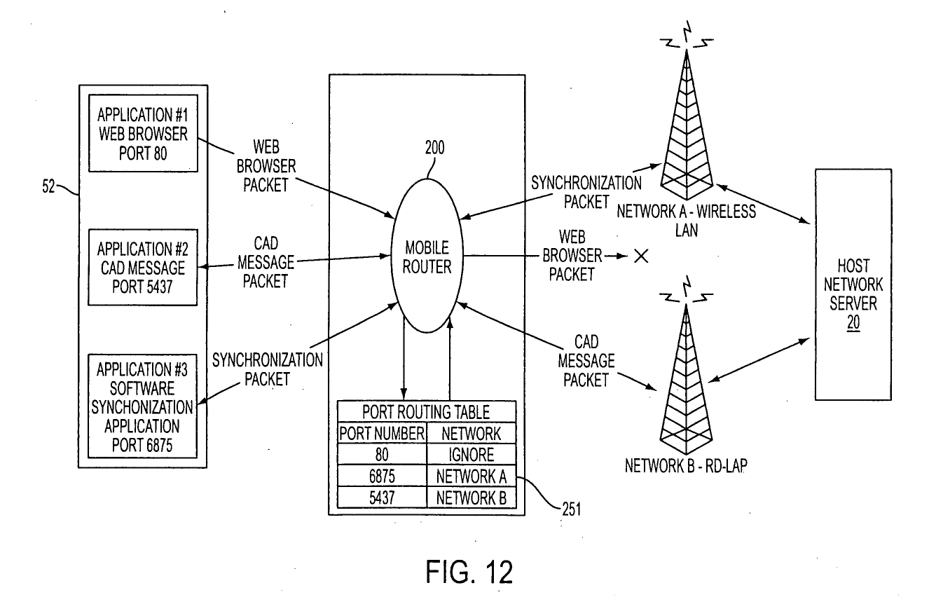

The Router Module process 450 listens to all available interfaces to determine network availability. The Router Module 450 requires the NetworkUp message to have been received before a wireless network 56 can be selected as the default route. The Router Module 450 then uses a variety of methods for determining network selection, such as time of day, message priority, and message size, but the final determination is always network availability, as previously discussed. Once the Router Module process 450 has determined the actively selected network, it updates its own internal route table to reflect the change. The Router Module 450 then generates a Route Registration (RR) message, an example of which is shown in FIG. 11, and sends it to the Host Network Server 20.

This RR message includes the following fields: Version, Command Number, Number of IP Addresses, a sequence flag, Gateway IP Address, and End Point IP Addresses. The Version byte specifies the version of the message. The Command bytes specify the type of message. The message types include Route Registration, Route Registration Acknowledgment and System Crash Route Registration. The number of IP addresses sets the number of addresses that are listed in the RR. The Gateway IP Address is the address of the currently selected hardware device. The list of IP addresses includes all of the end point IP addresses or subnets that can be reached via the gateway address. In other words, the software functions like a hub when more than one mobile device 52 is connected. For example, the software can be located in an automobile trunk and different mobile devices 52 could be located in the passenger compartment.

The RR alerts the Host Network Server 20 in order to update the route table as to all the end point IP Addresses that can be reached through this gateway address 56. Because the present invention allows for simultaneous parallel transmissions and multiple client devices, the RR ensures that the Host Network Server 20 is aware of all IP addresses that can be reached through this current gateway IP address. The Router Module 450 then waits for a Route Registration Acknowledgment (RRA) from the Host Network Server 20. If the Router Module 450 does not receive the RRA within a predefined time period, then additional RRs are sent at regular intervals until an acknowledgment is received. This retrying mechanism ensures that, even if the Host Network Server 20 is down, when it is restarted its route table always reflects the current routing configuration. If the Router Module 450 selects more than one network for the transmission of data, the route table is updated accordingly. The RR is then modified to alert the Host Network Server 20 to include both networks as the default route.

The Router Network Adapter 470 continually monitors the status of the networks 56. The Router Module 450 continuously passively monitors each RNA 470 for status change information. If a network's status changes at anytime, the appropriate RNA 470 sends a NetworkDown message to the Router Module 450. The Router Module 450 then dynamically changes the active route. The Router Module 450 can also use external influences, such as time of day, to dynamically change the route. This procedure for changing the route occurs transparently and independently from the normal transfer of packets.

At this point, any data received from any of the Router Network Adapters 470 is sent to the Router Module 450. The Router Module 450 verifies the IP checksum of the packet. If the packet's checksum fails, the packet is discarded. If the packet checksum is correct, the received packet is verified that it is an IP version 4 packet. This information is readily available in the IP header. If the packet does not meet the version 4 criteria, then it is silently discarded. The module will then decrement the Time to Live parameter in the IP header. If the TTL parameter is zero, then the packet is discarded and a Time to Live discarded message is sent back to the originator of the packet. The Router Module 450 looks at the end point IP address of the packet and routes it to the appropriate Router Network Adapter 470 or the appropriate end point IP address.

Next, the Router Network Adapter 470 receives the IP datagram from the Router Module 450. If the network is not an IP capable network it creates a data packet in the format required by the wireless network 56. The end point address of the newly created packet will be the hardware address (for non IP networks) of the corresponding interface on the Host Network Server 20. If the packet is an IP packet, it will be forwarded to the IP address of the corresponding Network Interface 214 (e.g., modem) on the Host Network Server 20. By sending to only the addresses of the interfaces on the Host Network Server 20, the user is assured that the packet will only go to the Host Network Server 20, even if the eventual destination of the packet has a different address. This ensures that the Host Network Server 20 can update and maintain its statistics and reporting capabilities. Additionally, it ensures that the Host Network Server 20 is always aware of the most recently used network, as well as the activity of all the mobile users. If the network 56 requires some procedure to establish a connection, then the Router Network Adapter 470 is responsible for this procedure (e.g., dialing a phone number on a circuit switched cellular network).

The second type of process that can be created is the AFS process. This process can be a standalone application that executes within the confines of the mobile routing device. It can perform any custom task that an end customer requires. An example is a store and forward process. The process can be written to manage the queuing of data, delivery of data and retrying of data transmissions.

The Router Module process 450 also supports the ability to dynamically alter the configuration of the software. The Router Module process 450 listens to an IP socket for any configuration requests. The configuration requests can come from either the mobile device 52 or the host application 13 on the LAN 10. The configuration requests are formatted in an IP UDP data packet. The Router Module process 450 always responds to the configuration request with a configuration response. Examples of these configuration requests include manually changing the route, requesting the network status, requesting the configuration, setting the configuration, etc. This functionality allows external applications to dynamically alter the routing of the device.

Port Routing System Overview

The present invention enhances the aforementioned wireless mobile routing system. With port routing, the Mobile Router 200 will not only simply notify the Host Network Server 20 of changes to the default network, the Mobile Router 200 will also notify the Host Network Server 20 whenever any network becomes available. The notification will allow both the Host Network Server 20 and the Mobile Router 200 to route packets over alternate, non-default networks as appropriate. The Mobile Router 200 will also be able to continue to route packets over the default network when appropriate.

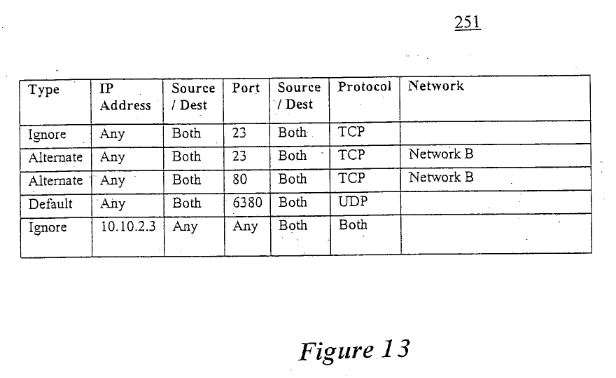

FIG. 12 is an illustration that represents an exemplary wireless mobile routing system having the port routing enhancement. In this example, three different applications (Application #1: web browser, port 80; Application #2: CAD message, port 5437; and Application #3: synchronization application, port 6875) are concurrently being executed on the mobile device 52. Data from the applications is being sent to the Mobile Router 200. When the Mobile Router 200 receives the data packets, the Mobile Router 200 consults a Port Routing Table 251 to determine which wireless network 56 (e.g., Network A: Wireless LAN and Network B: RD-LAP) the data should traverse to reach the Host Network Server 20. In the example shown in FIG. 12, data packets from Application #1, i.e., port 80, are not forwarded to the Host Network Server 20 because an “Ignore” indicator has been specified by the system administrator. On the other hand, data packets from Application #2, port 5437, are forwarded through Network B (RD-LAP) because the system administrator has specified Network B as the port routing path for port 5437. Similarly, data packets from Application #3, port 6875, are forwarded through Network A (Wireless LAN) because the system administrator has specified Network A as the port routing path for port 6875.

Port Routing Functionality and Port Routing Table

The functional details of port routing are now described. As discussed above, an aspect of the present invention includes the Port Routing Table 251. The Port Routing Table 251 stores additional configuration entries to support the enhanced routing capabilities. In one embodiment, the table includes fields enabling system administrators to specify port routing at a granularity that includes the protocol, IP address, port number and the specific network for routing. One embodiment of the Port Routing Table 251 includes five different fields that contain specific routing information, including port route type, protocol type, IP address, port number and the specified network.

The above mentioned system supports the ability to provide bi-directional communications. This being said, mobile routers can send packets inbound to the host network and the applications residing on the host network can send packets outbound to the mobile routers. Because of this bi-directional nature, a port routing table should exist on both the mobile routers and the host network server. Therefore, regardless of which side initiates the transmission, the packet will travel over the correctly chosen network.

In one embodiment, the Port Route Type field will contain an “Ignore”, “Alternate” or “Default” keyword. Each keyword specifies the routing behavior for a packet meeting user defined criteria when the packet is received by the Mobile Router 200.

If a packet's characteristics match user defined criteria stored in the Port Routing Table 251 and the corresponding Port Route Type field contains the “Ignore” network indicator value, then that packet will be returned to the source, without being sent across a wireless network, as a destination unreachable Internet Control Message Protocol (ICMP) packet. ICMP packets are provided to allow gateways or computers in a network to report errors or provide information about unexpected circumstances. There are several types of ICMP packets that can be generated, each one specifying a type of error condition. The port routing within the Mobile Router 200 generates a destination unreachable message under certain conditions, such as when a packet cannot traverse a network to reach its destination.

If a packet's characteristics match user defined criteria stored in the Port Routing Table 251 and the corresponding Port Route Type field contains an “Alternate” network indicator value, then the packet will be sent through the specified alternate wireless network.

If the packet matches an entry in the Port Routing Table 251 that contains a “Default” network indicator value, then the packet will be sent through the default network. Initially, the Default network type appears redundant because a Default route exhibits the same functionality as when no entry is present in the Port Routing Table 251. However, the Default route does become valuable when used in conjunction with a non-specific Ignore route. As an example, if a user adds an Ignore port route to automatically ignore all TCP applications, he may then want to add a Default route for port 80 (web browser). The addition of these two routes will disallow any TCP applications except for web browsers. The web browsers will then use whichever network is default.

The IP Address field will identify at least one IP address associated with the packet received by the Mobile Router 200. It can represent “All” IP addresses, or a specific IP address. If a specific IP address is entered, then the user has the choice of specifying if the IP address appears in either the source or the destination address.

The Protocol Type field identifies what type of transport level protocol will be subject to the port routing functionality. For instance, an embodiment of the present port routing invention may control TCP packets, UDP packets or packets with either protocol. TCP and/or UDP applications may take advantage of the port routing capability, because TCP and UDP protocols have the notion of a port. Route registrations may still be maintained with backwards compatibility to ensure non-port routing Mobile Routers 200 will continue to function.

The Port Number field identifies the IP port number of the packet received by the Mobile Router 200. The user can specify all ports, or has the option of specifying an individual port. The user also has the choice of specifying if the port number appears in the source or destination location in the TCP or UDP header.

The Network ID field identifies which network will be used to route the above-mentioned applications. This field would only be applicable if the route type is designated as “Alternate”.

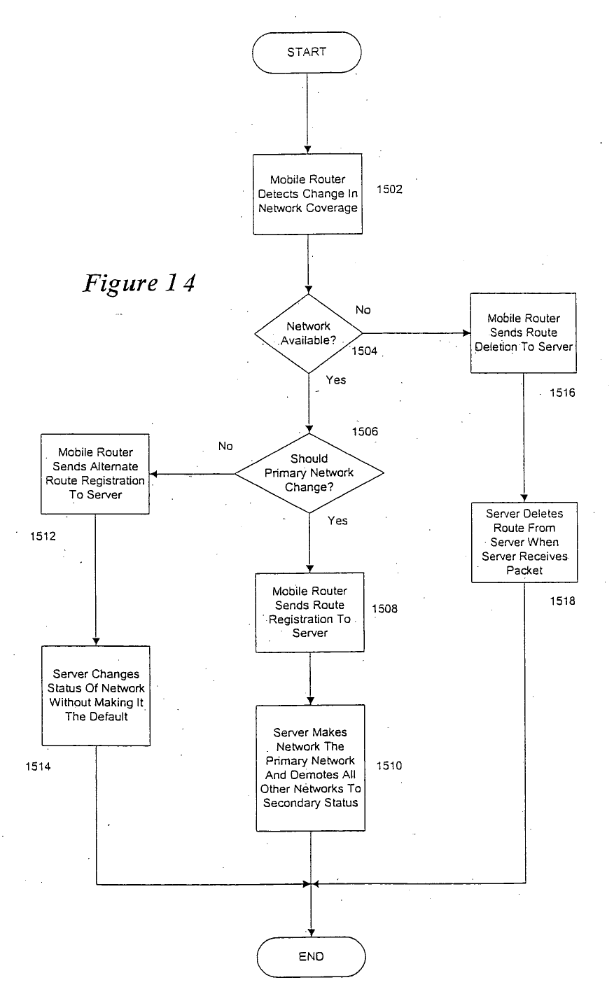

FIG. 13 shows an exemplary Port Routing Table 251 with a variety of port routing configurations. As seen in FIG. 13, it is possible to add many different port routing entries within the Port Routing Table 251. When looking up data in the Port Routing Table 251, the Mobile Router 200 always looks from the most specific to the least specific entry. Therefore, the most specific entries will be processed before entries that are more generic.

In the first row of the Port Routing Table 251, port routing is configured such that any TCP packet that is received and has a port 23 will be ignored. This route is referred to as an “Ignore” route. This port routing configuration does not allow the TELNET application to function through the Mobile Router 200. There is no need to define a network in the Network ID field because the data packets will not be routed over any network.

In the second row, an “Alternate” entry specifies that TELNET application packets will automatically be routed over the specified alternate network, which is Network B in this case. For example, this would only allow TELNET applications to function when they are in range of a certain network, i.e., Network B.

In the third row, the “Alternate” entry specifies that the Mobile Router 200 will explicitly route web browser packets (Port 80), in this case over Network B. As an example, this port routing configuration might be used if an administrator does not want her users to run web browsers over any network other than Network B.

In the fourth row, a “Default” entry is present. The “Default” entry specifies that any packet sent or received with the port number 6380 will use the current default network. In this example, the current default network is Network A. This behavior is also functionally similar to not using port routing.

In the fifth row, an “Ignore” entry is present. The “Ignore” entry specifies that any packet received with either a source or destination IP address of 10.10.2.3 will be discarded. There is no need to define a network in the Network ID field when an “Ignore” entry is present because the data packets will not be routed over any network. An example use of the Ignore entry is to restrict the communications to certain servers.

The above noted functionality may be implemented in either a distributed configuration or a centralized configuration. In a distributed configuration, all Mobile Routers 200 implementing port routing are configured separately. In centralized configuration, a system administrator may configure port routing (as well as other aspects of Mobile Router 200 configuration) on the Host Network Server 20 and have the configuration pushed to each Mobile Router 200

Aside from the static configuration defined in the Port Routing Table 251, there is additional data that must be shared at run time between the Mobile Router 200 and the Host Network Server 20 for port routing to function properly. Currently, mobile clients only notify the Host Network Server 20 of changes to the default network for that mobile client. In order for port routing to function properly, the mobile clients should enhance their operation to notify the Host Network Server 20 whenever any network enters an “in-coverage” state in addition to which “in-coverage” network should be considered active for that Mobile Router 200. The Host Network Server 20, in turn, should be enhanced to allow for multiple entries in its master route table for the same destination range while providing the ability to designate one network as the default route.

Port Routing Logic

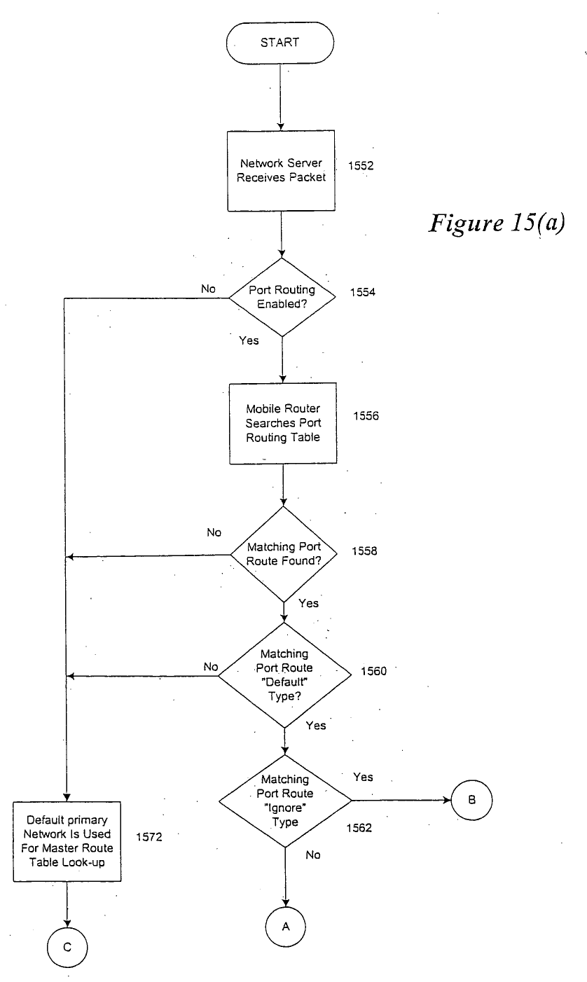

FIG. 14 is a flow diagram that depicts an exemplary manner in which the Network Server 20 monitors the networks registered in each Mobile Router 200. For port routing to operate correctly, the Host Network Server 20 must know the availability of all networks registered in each Mobile Router 200.

At step 1502, the Mobile Router 200 detects a change in network coverage. Next, at step 1504, it is determined if a network has become available. If a network has become available, then the Mobile Router 200 decides if the primary network should change at step 1506. If the primary network should change, the Mobile Router 200 sends a primary registration to the Host Network Server 20 at step 1508. Once the Host Network Server 20 receives the packet at step 1510, the Host Network Server 20 automatically designates the network as the primary network, thus demoting all other networks to secondary. Then the logic sequence ends.

If at step 1506 the primary network should not change (i.e., a backup network came into coverage), then the Mobile Router 200 sends an alternate route registration to the Host Network Server 20 at step 1512. When the Host Network Server 20 receives the alternate route at step 1514, the Host Network Server 20 then updates the status of the network without making it the default. Next, the logic sequence ends.

If at step 1504 the network is not available, then the Mobile Router 200 sends a route deletion message to the server at step 1516. Then when the Host Network Server 20 receives the route deletion message at step 1516, it will automatically delete that route from its table. Thereafter, the logic sequence ends.

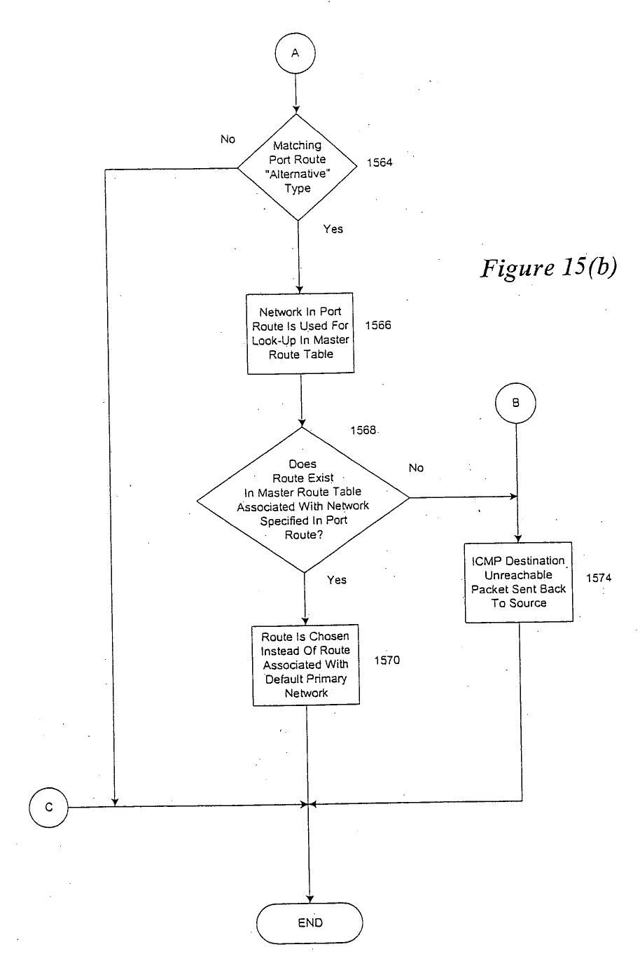

FIGS. 15(a) and 15(b) depict an exemplary manner in which routes will be determined in accordance with an aspect of the present invention. At step 1552, the Mobile Router 200 receives a packet. Next it is determined whether port routing is active at step 1554. If not, the packet is routed over the default primary network at step 1572. Then the logic sequence ends.

If at step 1554 port routing is found to be enabled, the Mobile Router 200 searches the Port Routing Table 251 at step 1556. If at step 1558 the packet does not match any of the entries in the Port Routing Table 251, the packet is routed over the default primary network at step 1572. Then, the logic sequence ends.

If at step 1558, the packet does match an entry in the Port Routing Table 251, the logic proceeds to step 1560. At step 1560 it is determined whether the matching entry includes a route type of “Default”. If so, the packet is routed over the default primary network at step 1572. Then, the logic sequence ends.

If at step 1560 a “Default” type is not found, the logic proceeds to step 1562. At step 1562, the logic determines if the matching entry has a route type of “Ignore”. If so, the packet is not sent and then an ICMP destination unreachable packet is sent back to the source at step 1574. Subsequently, the logic sequence ends.

If at step 1562 an “Ignore” type is not found, the logic determines if the matching port route entry has a route type of “Alternate” at step 1564. If “Alternate” has been specified, the network identified in the Network ID field is used for a lookup in the master route table (FIG. 5) at step 1566. Then the logic proceeds to step 1568 to determine if a route exists in the master route table associated with the network identified in the Network ID field. If at step 1564 the route is not an “Alternate” type, the logic sequence ends.

If at step 1568 no route exists in the master route table associated with the network listed in the Network ID field, then the packet is not sent and an ICMP destination unreachable packet is sent back to the source. For example, this would occur when the network identified in the Network ID field is not available (e.g., out of coverage, low signal strength, etc.) at step 1574. Then, the logic sequence ends. If at step 1568 a route exists in the master route table associated with the network listed in the Network ID field, then the logic proceeds to step 1570 where the packet is routed over the network identified in the Network ID field instead of the route associated with the default primary network. Subsequently, the logic sequence ends.

It should be noted that even though FIGS. 15(a) and 15(b) depict an exemplary manner in which the Mobile Router 200 receives a packet, the same logic may be used for port routing outbound from the Host Network Server 20.

Port Routing Configuration Screen, Editing Screen, and Default Route Table

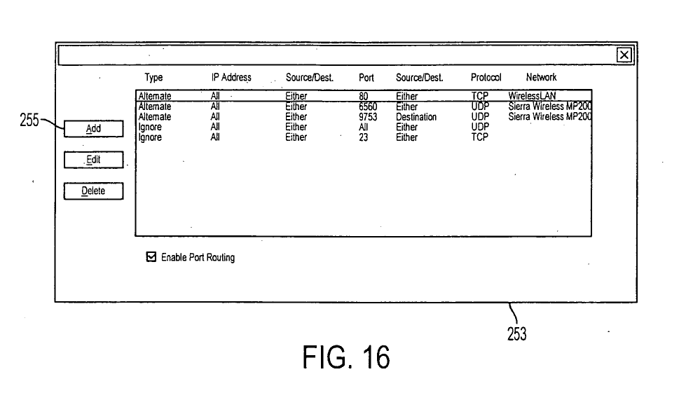

FIG. 16 is an exemplary screen shot that shows a Port Routing Configuration Screen 253. In this example, the mobile administrator has added several specific port routes. In the first row, the user specifically added a port routing definition to force all TCP packets with an 80 in either the source or destination port field over the network with the ID of Wireless LAN. In the second row, it is specified that all UDP packets with 6560 in either the source or destination port field will be forced to be sent over the Sierra Wireless MP200 network. A third entry specifies that any packet having a destination port of 9753 will also be forced over the Sierra Wireless MP200 network. In the fourth row, because an Ignore route with a wildcard port number is selected, all packets received with any port number either in the source or destination field will be ignored. The fifth line is an entry that requires specifically ignoring any packet with a destination or source port number of 23.

If or when there are no specific port routing entries listed in the Port Routing Table 251, the port routing functionality is disabled. In this circumstance, the default routes are being accepted. In this state, the Port Routing Configuration Screen 253 would inform the user that all traffic will be routed according to whichever network is available and selected as the highest priority.

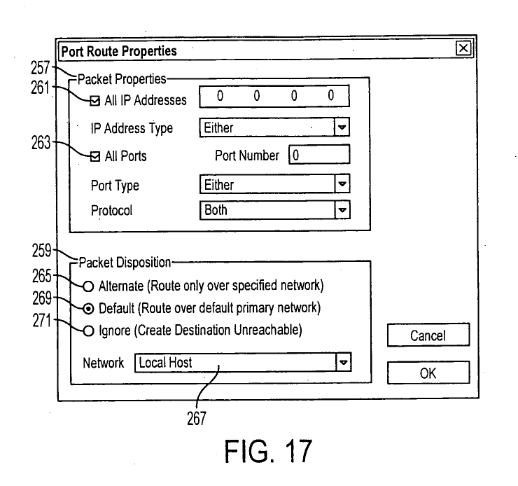

FIG. 17 is a screen shot of an exemplary port routing screen that allows the user to edit the port routing configuration. With this screen, the user would be able to add a configuration for the port routing. This screen appears when the user clicks the Add Button 255 from the Port Routing Configuration Screen 253, as depicted in FIG. 16.

The configuration window is separated into two sections. In the Packet Properties section (257, top half), the user is able to specify the actual packet criteria to which the specific rule should be applied In the Packet Disposition section (259, bottom half), the user will be able to specify the routing of the packet that the rule describes.

The “All IP Address” check box 261 specifies whether the entry applies to all IP addresses or just individual ones. If the user wishes to specify a specific IP address, then she will also have the option of specifying if it appears in the source, destination or either location within the UDP or TCP header.

The “All Ports” check box 263 allows the user to either specify a specific port number or specify all ports. If the user has specified all ports, the user will also be able to select if the port number appears in the source, destination or either location within the UDP or TCP header. The “Protocol” field specifies whether this entry applies to TCP, UDP or both types of IP packets.

In the Packet Disposition section 259, three outcomes are listed that can occur when a packet has been received. If the “Alternate” radio button 265 is selected, then when a packet arrives that matches the user selected properties, it will only be routed over the network specified in the “Network” drop down list box 267. If the “Default” radio button 269 is selected, then when a packet arrives which matches the user selected properties, it will be routed according to the default network configuration. Finally, if the “Ignore” radio button 271 is selected, then anytime a packet is analyzed that matches the user defined criteria, it will be ignored and an ICMP destination unreachable message will be sent back to the sender of the packet.

FIG. 18(a) is a screen shot of an exemplary sample presenting information from default route table. The invention has such a window that will display the active routes being used by the mobile application or device on the system. Since microprocessors store data in a binary format, the internal format of the route table will not be readable by humans. Therefore the invention allows a graphical user interface to be used to display the packets in a more meaningful presentation to the administrator.

FIG. 18(b) is a screen shot of an exemplary second “view” of the route table to display the non-active or alternate routes. When the “Primary” route table tab 273 is selected, the Primary route table will display any route that is active, such as shown in FIG. 18(a). When the “Alternate” route table tab 275 is selected, then the Alternate route table displays only routes that are inactive. In this screen the user has the option of clicking on either the “Primary” tab or the “Alternate”. The view will then be automatically updated to reflect the particular route table.

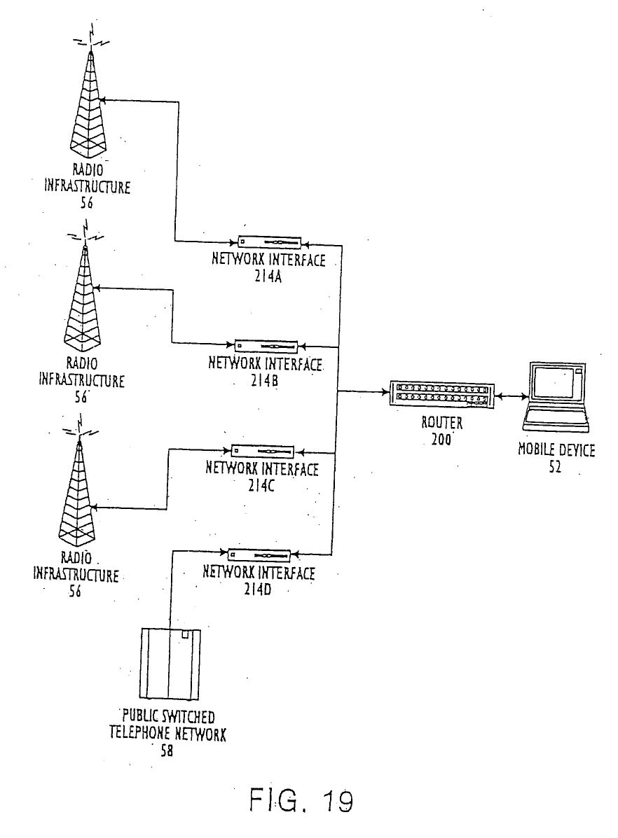

Referring now to FIG. 19, therein is illustrated a general overview of another embodiment of the present invention which includes a mobile Router 200 in accordance with an aspect of the present invention. The Router 200 provides the mobile application or device 52 with the capability to selectively transmit and receive data over a plurality of radio frequency infrastructures 56 and/or the public switched telephone network 58 in accordance with user configured parameters.

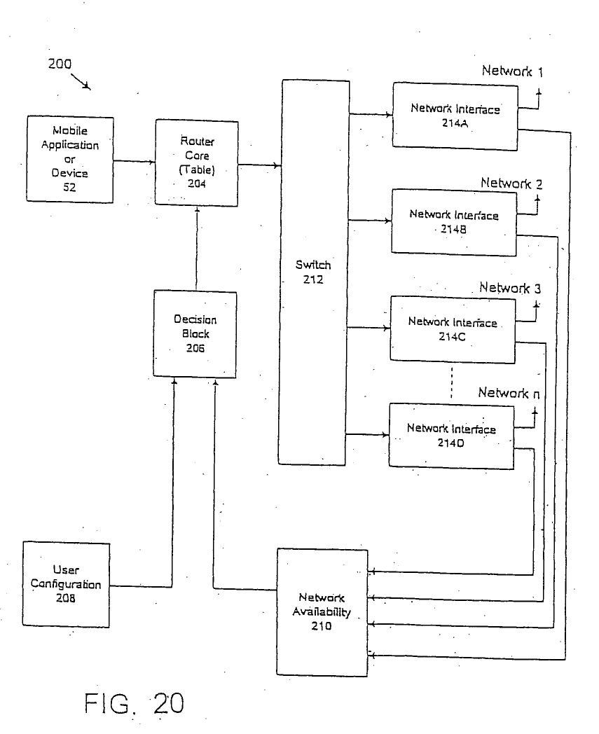

Referring now to FIG. 20, therein is illustrated a schematic block diagram of the mobile Router 200. In the following description of the Router 200, each of the elements will be initially generally described and in greater detail thereafter. As shown in FIG. 20, the mobile application or device 52 may be attached to multiple Networks by the Router 200 through Network Interfaces 214A-D, a Router Core 204, and a Switch 212. The Network Interfaces 214A-D provide connectivity for data between the Switch 212 and the various Networks infrastructures (e.g., radio infrastructures 56 and public switch telephone network 58) through which the mobile device or application 52 connects to a communications network. The Switch 212 is actuated by the Router Core 204, and sends data to a fixed host application or device (e.g., RNC 20) via the selected network. The Network Interface 214 provides information to the Network Availability process 210, which sends this information to the Decision process 206. The Decision process 206 operates in accordance with User Configured parameters 208 which specify when and through which Network the data is to be transmitted. The decision process 206 monitors the User Configuration parameters 208, and the Network Availability 210. When the Decision process 206 (in accordance with User Configuration 208 parameters) specifies that a Network (e.g., Network 3) different than the Network currently in use (e.g., Network 1) should be used, the Decision process 206 checks the Network Availability 210 for the particular Network to be switched to. If the Network is available, the Decision process 206 instructs the Router Core 204 to switch to the new Network. The Router Core 204 then updates routing tables (not shown) maintained within the Router Core 204 to reflect the new data path, and actuates the Switch 212 to connect to the new Network. Data may then flow over the new Network. In accordance with an aspect of the present invention, data may flow inbound to the fixed host through one Network, and outbound to the remote mobile Application or device 52 through the same Network, or through a different Network.

With reference to FIG. 20, the mobile application or device 52 may comprise a software application running on a portable or laptop computer performing a variety of functions as programmed by the software application (e.g., database services) The Application or device 52 may also comprise a special purpose device designed to perform a particular function, such as a credit card reader or barcode scanner. The Application or device 52 may generate a data stream which is sent to a fixed location (e.g., a host computer infrastructure 10).

An exemplary application running on the mobile device 52 is a mobile remote client application which provides the remote user with the capability to send and retrieve data from a fixed database server application. The data may consist of customer records which, for example, may be used by service personnel operating a fleet of vehicles to service customers scattered about a wide geographic area. In the exemplary application, the mobile client application may request customer records from the fixed database server, and display the records for viewing by mobile service personnel. The mobile client application may send updated records to the fixed database as the service personnel finish assigned tasks. The updated records may contain a service history, equipment upgrades, and repairs for each customer.

Another exemplary application running on the mobile device 52 may be a client application which retrieves a list of dispatched jobs to be performed by the service personnel during each day. The jobs may be uploaded to the remote mobile device 52 each morning and stored in another client application in the mobile device 52. As the service personnel change job locations, the status of each job may be updated to indicate a status, e.g., en route, arrived and finished with comments. The status may be sent from the application to the fixed home office, so a dispatcher at the home office is aware of the locations of service personnel in the field.

By way of non-limiting examples, the mobile device 52 may comprise a portable or laptop computer; a computer having an embedded Router 200; a terminal or terminal emulator; a data gathering device (e.g., a SCADA system or remote telemetry system for obtaining data from a remote location for forwarding to a central location for processing); a card-swipe reader device (e.g., credit/debit/bank cards) for use in a mobile billing application, such as a taxi or mobile food cart; a smart-card reader; a logging device, such as those used in a package delivery system or fleet; a device for reading bar codes (e.g., for inventory control); and a remote application with data to send or to receive, from a fixed application or device (e.g., remote diagnostic tool). The above-noted applications are provided merely for exemplary purpose, and other applications and mobile devices 52 may be used with the Router 200 of the present invention.

Typically the device or Application 52 sends and receives data using a variety of protocols (e.g., Internet Protocol (IP)/transparent (via MDC 54)/ack-nack, etc.). The use of a variety of protocols provides for open transport of data throughout many networks, and in particular, networks which support open standards such as IP. However, many proprietary networks which require interface and/or protocol translation remain in use. In the Router 200 of the present embodiment, the function of interfacing with networks and protocol translation may be performed by the Network Interfaces 214A-D.

According to another aspect of the invention, other types of devices may be connected to the Network Interface 214. Such devices may be used for functions other than data and voice communication. By way of non-limiting examples, these devices may include Global Positioning System (GPS) receivers and application processors.

The Router Core 204 is a function which shuttles messages between the Application or Device 52 and the various Networks. In accordance with the present embodiment, the router Core 204 may control which network of a plurality of usable network messages are to travel over, and connect access ports (described below) to each Network and the Application or Device 52.

The Router Core 204 may also comprise a list of all possible “names” or “addresses” to which data may be sent, or from which data may be received. The local “names” or “addresses” of the Router Core 204 are stored in tables within a memory (not shown) of the Router Core 204. Thus, the Router Core 204 may serve as a communications “address book” for the Router 200 of the present embodiment. The Router Core 204 also checks all messages passing through, and decides, based on the address and/or name entries in the tables, if the message is relevant to the attached Application or Device 52, or to the fixed host (e.g., RNC 20). The address of the fixed host may be stored in the Router Core table as well. In accordance with the table entries, received messages may be determined to be valid or invalid. The Router Core 204 may also actuate the Switch 212 in accordance with the output of the decision process 206. The Switch 212 is actuated such that incoming and outgoing messages can be sent through the “current” network, as determined by the decision function 206 (to be described below).

The Switch 212 may comprise a message multiplexor, i.e., the Switch 212 performs a one-to-many function for in-bound messages (to the fixed hosts), and a “many-to-one” function for outbound messages (from the fixed host). As noted above, the appropriate network selection is made by the Router Core 204 in accordance with the output of the decision process 206. Messages travel through the Switch 212, the Router Core 204, and the current Network Interface 214.

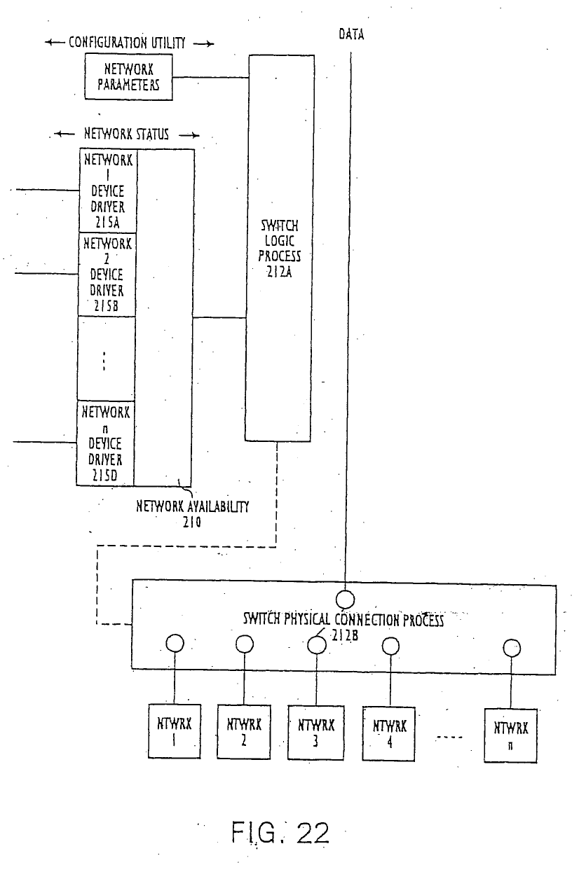

Referring to FIG. 22, the Switch 212 may be implemented using a combination of hardware (e.g., multiple electronic ports, one per Network Interface 214) to perform the physical connection process 212B, and software (e.g., handlers which are interrupted at each character to move the character to either the Router Core 204 (outbound), or to the current Network Interface 214 (in-bound)) to perform the switch logic process 212A.

As a non-limiting exemplary hardware implementation, the Switch 212 may comprise an 80386EX microprocessor, running at 33 MHZ, 256 kilobytes of FLASH ROM, 512 kilobytes of static RAM, six asynchronous serial ports, two TTL-to-RS232 convertors interfacing with two of the six serial ports directly to compatible devices external to the Switch 212, and four internal TTL serial interfaces to internally-mounted daughter boards, which carry Network Interfaces 214A-D. Each Network Interface 214 mounted on a daughter board may include a power supply for the Network Interface, a serial interface to the 80386EX microprocessor, and an interface to the outside network. The outside network may be a radio, a LAN, an antenna (for internally-mounted radios in the Network Interface 214), or other device accepting or supplying data from/to the Router 200.

The Switching function of the Switch 212 is provided by each serial Network Interface port at the 80386EX microprocessor, and the software residing in FLASH ROM. The software logic determines which Network Interface to use for transmission and receipt of data. The decision is implemented in the Switch, by selecting a physical serial port (and therefore which Network Interface) is to be used as the current Network. The Decision software in the FLASH ROM instructs the microprocessor to send the data to a specific serial port (which is mapped to specific physical addresses within the address range of the 80386EX microprocessor). The microprocessor then constructs the next message in the message buffers in RAM, and sends the message through the specific serial port which is designated as the “current Network” Interface port. The data then goes to the Network Interface (e.g., network interface 214A) connected to that specific serial port and on to the Network infrastructure. Received data is input to the Network Interface (e.g., network interface 214B which may be set to the “current Network” serial port) and the microprocessor, where the received data is processed by the microprocessor. In accordance with an aspect of the present invention, messages which are received through Network Interfaces which are not designated as the “current Network” are ignored.

The Network Interfaces 214A-D are devices which present data to, or obtain data from the radio operating at the various R.F. Network frequencies, bandwidths, and modulations. The Network Interfaces 214A-D may provide a port through which messages pass, to and from the Switch 212. The messages are typically in the form of a sequence of serial digital bits. The Network Interfaces 214A-D also may provide a modulator/demodulator function which transforms the digital data into an analog form which may be easily sent through the R.F. Network voicepath, based on characteristics of the assigned frequency band of the R.F. Network. The characteristics of analog transmissions are typically bandwidth (in Hertz, or cycles per second), noise present in the Network, and assigned frequency of the R.F. Network. Further, the Network Interfaces may interface with a radio, which may be included within the Network Interface 214, or may be mounted externally to the Router 200 (as shown in FIG. 19). The Network interface 214 radio interface comprises the actual physical connections to the radio for the voicepath data, the muting function (if present and/or required) and the functionality for issuing a Press-to-Talk to the radio, and for receiving the Transmit Grant signal from the radio; both are used for handshaking between the radio network and the Network Interface 214. This handshaking may be necessary for proper timing of the data out onto the RF Network. The muting function is used for silencing received signals which represent data, rather than voice traffic, which enables a remote user to mute the audible noise of the data traffic, which can be annoying to the remote user.

Examples of Network Interface 214A-D include the MDC 54 and the NovaTel Wireless NRM-6812 Cellular Digital Packet Data (CDPD) modem. Where the network interface 214 comprises the MDC 54, the radio is mounted external to the MDC 54, whereas in the NovaTel example, the radio and the network interface are integrated into a single unit.

As noted above, the Network Interfaces 214 provide connections to various types of networks. These networks may be wired (for example Public Switched Telephone Network 58), or wireless (for example Cellular Digital Packet Data (CDPD)). The following non-limiting list includes networks that may be interfaced to the Router 200 by the Network Interfaces 214A-D: private voice radio including conventional and trunked radios (e.g., using MDC 54), Cellular Digital Packet Data (CDPD), Spread Spectrum (e.g., direct sequence and channel-hop), GSM, GPS receiver, satellite transponder, RDI (Ericsson) interface, AMPS, RAM Mobile (Mobitex), RS232, RS485, Angel (AT&T), Asynchronous Transfer Method (ATM), Integrated Services Digital Network (ISDN), public switched telephone network (PSTN (POTS) telephone network), Ethernet, Ardis, Personal Communications Services (PCS), and any other network which is either transparent or operates using a specific protocol.

The specific protocols to the above-listed networks are implemented in the Network Interfaces 214A-D. These protocols may be very different, and therefore incompatible with each other. Additionally, a translation device may be provided in each Network Interface 214 to translate between IP and the particular network protocol. By providing such a translation device, the Application or Device 52 can use IP data regardless of the particular network the Application or Device 52 is actually using.

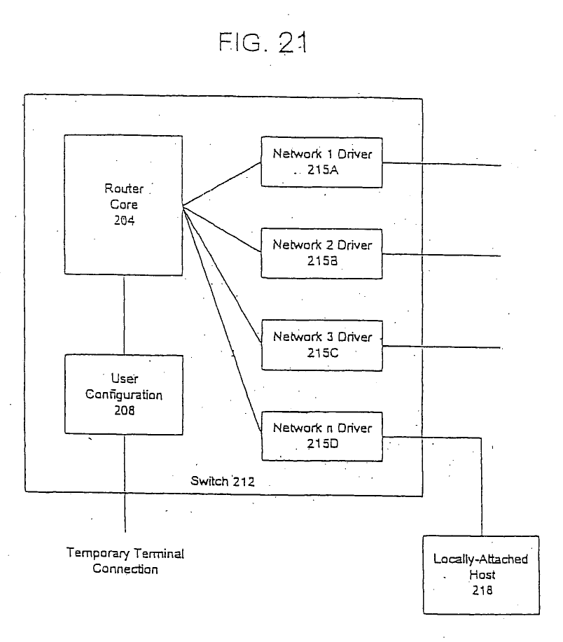

Referring to FIG. 21, a description of the functional components of the Router 200 will now be described. The Router 20 may be implemented as an autonomous device with multiple connections to the networks through which data is to be routed. The user Configuration Interface 208 provides a means whereby an external device such as a keyboard/terminal may be used to supply configuration information such as preferred routes, network node addresses, etc. to the router. Such information is accepted by the Configuration Interface 208 and is placed into a non-volatile store (e.g., memory) which may be queried by other router components. In addition, capability may be provided whereby diagnostic information may be requested from the router and sent to the terminal device for evaluation by a technician.

The Router Core 204 is responsible for making all routing decisions. For a given destination network address specified within a data packet or datagram received from one of the network interface drivers 215A-D, the most-preferred path will be selected and the data packet or datagram forwarded through the preferred network interface driver 215A-D. Routing decisions are generally based upon such metrics as network speed and interface availability. Other metrics such as destination network, time of day, type of data, etc. may also be incorporated into the routing decision. Further, routing decisions may be made at the packet level such that each individual packet of data may be transmitted and/or received on different networks in accordance with the user configured parameters 208.

Exemplary Network Drivers 215A-D may include an Ethernet Driver, a Token-Ring Driver, and a Serial PPP Driver. The Ethernet Driver provides a means for sending and receiving data through an Ethernet-type network. The function of the driver is to shield the Router Core from the details of network media access. The Token-Ring Driver provides a means for sending and receiving data through a Token-Ring-type network. The function of the driver is to shield the Router Core from the details of network media access. The Serial PPP Driver provides a means for sending and receiving data through a PPP-based serial data link. The function of the driver is to shield the Router Core from the details of network media access. Other drivers 215A-D may be provided to interface with other types of networks as necessary.

The Network Availability 210 (see also FIG. 20) is a function which periodically interrogates each installed Network Interface 214 in the Router 200 and may determine if the Network Interface 214 is installed; if the Network Interface 214 is properly configured and functioning properly; if the Network Interface 214 is connected to the Network, on-line, and available for sending/receiving messages; and if the Network Interface 214 is in good health. The above interrogation process may be accomplished by monitoring a timer tick (provided by the switch microprocessor), which instructs the Network Availability 210 to query each Network Interface 214. When the timer tick occurs, the Network Availability 210 function interrogates each Network Interface 214 as noted above. The status of each Network Interface 214 is then passed to the Decision process 206, which determines what the “next Network” will be if the result of the interrogation indicates that the “current Network” is experiencing transmission problems.

The Network Availability 210 of each Network Interface 214 is determined in a manner specific to the particular interfaced Network. For example, if the Network is CDPD, the Network Availability 210 interrogates the network to determine if the Network Interface 214 is currently registered with the Network, and therefore active. Also, in the CDPD network, the Network Availability 214 determines if the Received Signal Strength Indication (RSSI) is sufficient to transmit relatively error-free data. For example, in the NovaTel CDPD Network Interface a RSSI of −100 dBm will provide for good data transmission qualities. Thus, if the Network Availability 210 function queries the NovaTel CDPD Network Interface for the RSSI, and the response is −110 dBm, then the signal is too weak for error-free transmission, and therefore cannot be used at this time. This information is passed to the Decision process 206 to determine if the “current Network” should remain the “current Network”, and if not, to determine what the “next Network” should be.

The User Configuration 208 block is used to define user configurable parameters by which the Router Core 204 selects the “current Network” and the “next Network”. The Router parameters may include the date and time (e.g., yr-mo-da, hh:mm:ss), and the Network Interface 214 installed in each of the internal slots of the Router 200. According to the present embodiment there are six internal slots to accommodate Network Interfaces to any of private voice radio using e.g., the MDC 54 and a variety of radios, both conventional and trunked; Cellular Digital Packet Data (CDPD), such as Sierra Wireless or NovaTel CDPD modems; spread spectrum, either direct sequence, or channel-hop, as Xetron Hummingbird spread spectrum modem; GSM, such as Ericsson serial GSM module; GPS receiver, such as Motorola VP Encore GPS receiver, or Trimble SVEE Six receiver; satellite transponder; RDI (e.g., Ericsson) interface, implemented via a software protocol module and quasi-RS232 interface to radio; AMPS; RAM Mobile (e.g., Mobitex); RS232 default and fixed for example in slots 1 and 2; RS485; Angel (e.g., AT&T); ATM; ISDN; PSTN; Ethernet; Ardis; PCS; any other network which is either transparent or operates using a specific protocol; and none. Although six slots are disclosed herein, other numbers of slots may be provided.

Other user configurable parameters include: the priority of each internal slot, (e.g., 1 to 6) where the slot with priority 1 is the default startup slot and Network; baud rate of each slot (a default rate may be set to 9600 bits per second, but may be configured to be any standard baud rate, divisible by 300, up to 115.2 kilo bits per second); cost per kilobyte per slot (e.g., $0.xx per kilobyte where the least costly slot that is available and highest priority will be default); protocol per slot (e.g., none, Point to Point (PPP), Serial Line Internet Protocol (SLIP), Hayes “AT” commands, transparent); slot mode, for example, transparent, PSTN, cellular, IP, receive only; slot name or address or phone number; slot to be used for diagnostics (e.g., default may be set to slot 2); slot muting to be used (e.g., none, PL, DTMF, other); number of retry transmissions per Network Interface (per slot) before declaration of Network Interface failure (e.g, 0-10); if slot Network Interface needs to be configured before it can operate (e.g., y,n); slot to be used for remote display (e.g., default may be set to slot 2); slot to be used for Device or Application 52 (e.g., a connection to a mobile computer; default is slot 1); and frequency at which Network Availability 210 is checked (e.g., default may be set to five seconds). Other user configurable parameters may be introduced and configured as necessary.

The User Configuration 208 function provides the user with the capability to instruct the Router 200 how to select a particular Network. These metrics may include, but are not limited to: which Network is connected to which Router port; time of day and date, priority (switching sequence) of each Network, cost per packet of each Network, and preferred default Network.

On power up, the User Configuration 208 is checked to determine if it is current. If the User Configuration 208 is determined to be out of date, the end user is requested to input a configuration. The user is notified by blinking LEDs on the front panel or by a message sent to the mobile device 52. If the User Configuration 208 is determined to be current, no user input is requested.

Further, each Network is continuously evaluated for health and connectivity status. There are a number of parameters which are examined to determine this, including, but not limited to: Received Signal Strength Indication (RSSI), Clear to Send (CTS), Channel Clear/Channel Ready, and Transmit Grant.

The Decision process 206 continuously examines the User Configured parameters in the user configuration block 208, to determine the next Network to use, in case the current Network becomes unavailable to send or receive data. Such an unavailability may arise because the remote user (and consequently the Router 200) has moved beyond coverage of the Network, or because a problem has occurred with the current Network or the Network Interface 214.

After the Decision process 206 has determined the next Network to use, the decision process 206 queries the Network Availability 210. If the next Network is available, then the Decision process 206 updates the routing tables in the Router Core 204. The Router Core 204 will then actuate the Switch 212 to physically connect the next Network as the current Network.

The Decision process 206 uses the User Configuration 208 parameters defined above to determine the specific criteria for each slot, to be used when deciding if the current Network is to remain the current Network, and if not, what the next Network shall be. Once the decision process 206 has made a tentative decision to switch to another Network (i.e., the next network is to become the current network), it checks the Network Availability 210 to ascertain if the Network is actually installed, configured, on-line, and in good health. For example, if the current Network is configured as priority #3, and the Network Availability 210 of the priority #2 Network updates to, for example, “installed, configured, on-line, and in good health”, then the priority #2 Network becomes the next Network. The Decision process 206 will instruct the Switch 212 to switch the priority #2 Network to the current network. Should the Decision process 206 decide to change Networks, it conveys an instruction to the Router Core 204 by instructing the Router Core 204 what the next Network Interface 214 is to be.

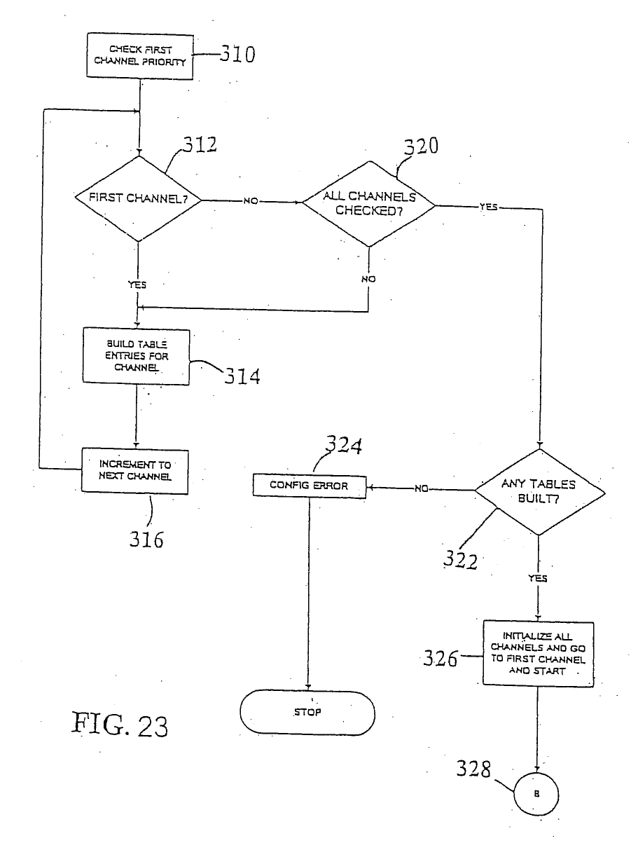

The process of the Decision process 206 checking the User Configuration 208 and the Network Availability 210 continues indefinitely, and is described in detail in FIGS. 23-26. Generally, the process helps to guarantee that the mobile user always has access to a Network for sending and receiving data. This process also allows what is known now as “seamless roaming”. This means that the mobile user can move between Networks and continue to have reliable data transmission on the different Networks.

FIGS. 23-26 illustrate the logic of the software in the router. Referring now to FIG. 23, there is shown an exemplary initialization routine which builds the tables in the Router 200. Upon initialization of the system, at Step 310 the first channel priority is checked. At Step 312, it is determined whether or not the first channel is being examined. If it is the first channel, at Step 314, table entries for the first channel are built. Information which is included in the table may be, e.g., IP address of the destination, intervening intermediate IP addresses, the assigned port, channel priorities, and the application being used. Typically channel one is assigned the highest priority. After the tables are built, the processing increments to the next channel at step 316. From Step 316, processing returns to Step 312. If at Step 312 it is determined that the channel being checked is not the first channel, processing proceeds to Step 320 to query whether all channels have been checked. If all channels have not been checked, processing returns to Step 314 to continue building the table entries via steps 314 and 316 until all channels have been checked.

Once it has been determined that all channels have been checked, at Step 322 it is determined whether any tables have been built. If no tables have been built, at Step 324 a configuration error is recognized and the processing stops. Tables may not have been built previously, e.g., if there are problems with the IP address, i.e., there was no destination address. If at Step 322 it is determined tables were already built, processing proceeds to Step 326 where all channels are initialized and data transportation begins via the first channel.

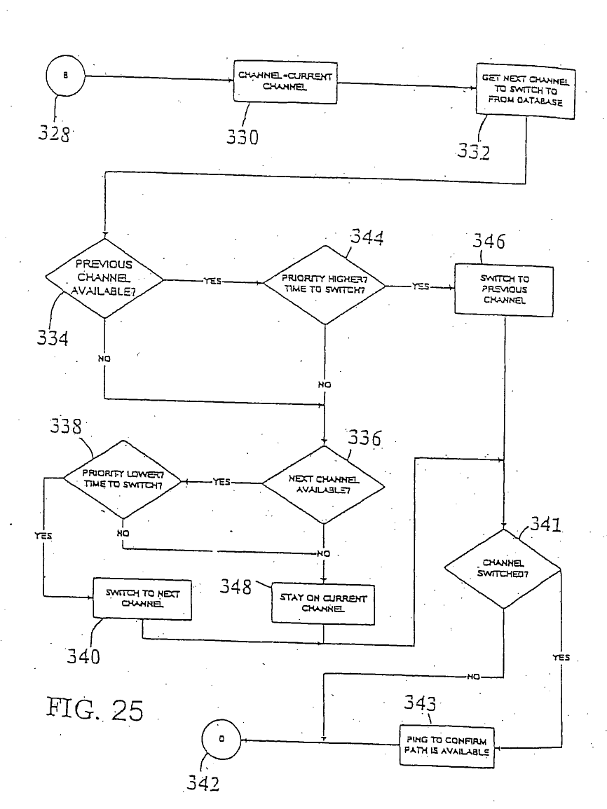

From Step 326 the processing proceeds to Step 328, also shown in FIG. 25, which illustrates an exemplary flow diagram of the Router 200 logic for accounting the Network Availability 210 (FIG. 20) and User Configuration 208 (FIG. 20) to decide which channels to use for data transport. Beginning at Step 328, processing proceeds to Step 330 where the channel is set to the current channel in a database which is described in more detail below. From there, processing proceeds to Step 332 to retrieve the next channel to switch to from the database. The database is stored in flash memory and contains configuration information for each channel including how each channel is set up in the Router 200 and what configuration values are for each Network Interface 214A-D. In addition, the database stores which channel is current and the history of previous current channels. The tables discussed with reference to FIG. 23 at Step 314 are also stored in the database.

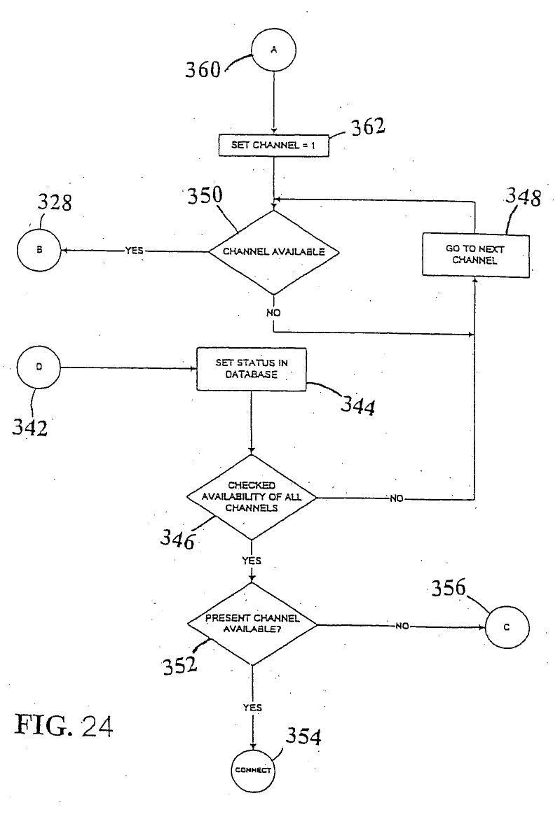

At step 334 a determination is made as to whether the previous channel is available. Of course if this is the first time through, no previous channel will exist. If the previous channel is not available, at Step 336 a determination is made as to whether the next channel is available. If the next channel is available, at Step 338 a determination is made as to whether or not the priority is lower and it is time to switch. The determination is made by looking at the information in the User Configuration 208 (FIG. 20). If it is time to switch, at Step 340 a switch to the next channel is made. From there, processing continues to step 341, where it is determined if the channel was switched. If the channel was switched, processing continues to step 343 where a ping is sent to confiner the path is available. From step 343, the processing continues to Step 342, also shown in FIG. 24. If, at step 341, it is determined the channel was not switched, processing continues to step 342.

Returning to Step 334, if it is determined that a previous channel is available, at Step 344 an inquiry is made as to whether or not the previous channel has a higher priority and it is time to switch. The determination is made by consulting the information in the User Configuration 208 (FIG. 20). If it is determined the previous channel is a higher priority and it is time to switch, at Step 346 a switch to the previous channel is made. From Step 346, the processing proceeds to Step 341 as previously described.

If at Step 344 it is determined that it is not time to switch and the priority is not higher, processing proceeds to Step 336 where it is determined whether the next channel is available. If the next channel is not available, at Step 348 the current channel is not switched and the processing proceeds to Step 341 as described above. If at Step 336 the next channel is available, then at Step 338 the inquiry into priority and time to switch is made as previously described. At Step 338, if it is not time to switch and the priority of the next channel is not lower, the Router 200 stays on the current channel at Step 348.

Refer now to FIG. 24 which illustrates a flow chart of exemplary logic for checking the availability of each network interface. Starting at Step 342 processing proceeds to Step 344 where the status of the channel being used is recorded in the database. Furthermore, at Step 344, the Router 200 front panel LED's are updated. If at Step 346 it is determined the availability of all channels has not been checked, at Step 348 the next channel is identified and at Step 350 the next channel's availability is polled. A channel is not available if it is being used for a mobile device 52 i.e. the channel is already one end of the network. If the channel is not available, the processing returns to step 348. If the channel is determined to be available at step 350, processing proceeds to Step 328 also shown in FIG. 25.

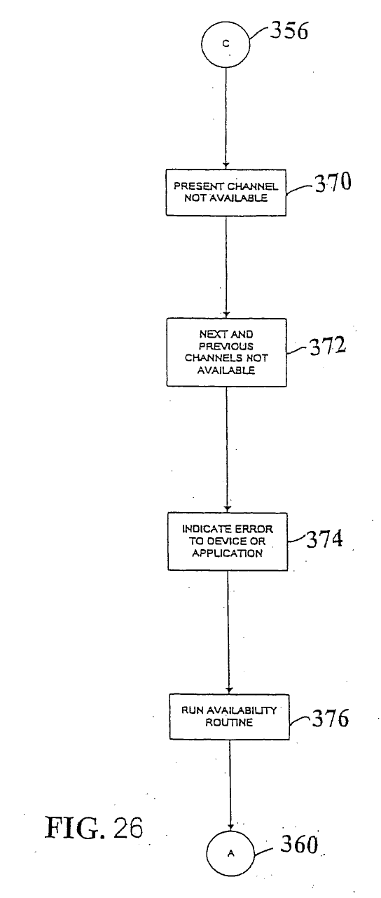

If at Step 346 it is determined that the availability of all channels has been checked, at Step 352 the availability of the present channel is determined. If the present channel is available, a connection is made at Step 354. If the present channel is not available, processing proceeds to Step 356 for error handling. The error handling procedure is discussed with reference to FIG. 26 below. Upon completion of the error handling procedure, at Step 360 the channel is set equal to one at Step 362. At Step 350, the procedure continues as previously described.

Referring now to FIG. 26, which is an exemplary flow diagram of the Router 200 error handling logic, Step 356 continues from FIG. 24. At Step 370, the present channel is deemed to be non-available. At Step 372, the next and previous channels are also confirmed to be non-available. At Step 374 an error is indicated to the device or application. At Step 376 an availability routine is run such as that described previously. From the availability routine at Step 36, the processing continues to Step 360 as discussed with reference to FIG. 24.

The Router 200 of the present invention may be used inside a mobile vehicle, or carried by a person in a portable application. Further, the Router 200 may be provided as an external component connected to a portable device (e.g., a laptop computer) or may be implemented within the portable device, such that the portable device and the Router 200 are provided as one integrated unit. Further, the Router 200 may be used in conjunction with, or integrated into measuring and testing equipment, and transmission equipment. Such a remote device may be needed for very remote monitoring applications, such as wildlife studies, etc., necessitating the use of multiple Networks.

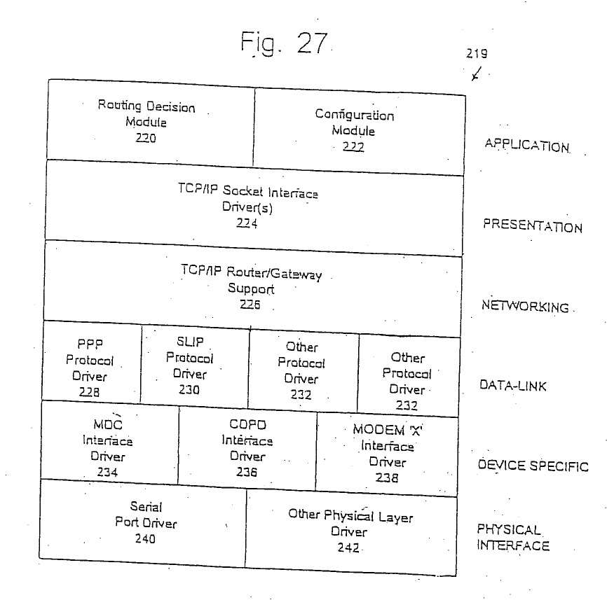

Referring now to FIG. 27, there is shown the software architecture 219 of the Router 200 in accordance with an embodiment of the present invention. The architecture is strictly layered in that data flows only vertically between adjacent layers. The definition of each layer will now be described.

The Application layer consists of various processes that perform services directly related to the function(s) for which the device is defined. This includes such services as defining a device configuration, making decisions about which route to select for the transport of data and performing various diagnostic functions.

The Presentation layer consists of a protocol-independent insulating layer between the applications and the lower-level networking functions. The Presentation layer implements a Berkley sockets compliant application programming interface (API).

The Networking layer performs all processing related to handling the Internet Protocol (IP). The main function of the networking layer in this environment is the routing of data passed into the layer from either above or below back out through selected Network Interfaces to deliver that data to the intended destination. The relationship of destination and network interface is maintained by the Configuration Module and Routing Decision Module applications.

The Data-Link layer provides logical Network Interfaces through which the Networking Layer may send and receive data. One or more of these Network Interfaces may be active at any time. At least one network interface must be active for the device to function properly. The main purpose of the Data-Link layer is to insulate the Networking layer from the details of the many link-level protocols used to transport data.

The Device-Specific layer deals with the details of establishing and maintaining data communications through various types of communication devices such as radios, modems and data controllers. Each Device-Specific driver handles the vagaries of configuring and interfacing with various types of communication devices while presenting a uniform interface to the Data-Link layer.

The Physical Interface layer handles the direct interface to external components. For example: A serial port driver may handle the sending and receiving of individual data bytes through a specific type of serial controller such as an Intel 8250.

A description of the functionality supported by various module blocks as presented in FIG. 27 will now be described.

The Configuration Module 222 is an Application layer module that allows a technician to maintain a database of device configuration information. A technician may access the Configuration Module via a diagnostic serial port. Another implementation may allow a technician to access the Configuration module through any of the defined Network interfaces via a standard socket.

The Routing Decision Module 220 selects the preferred network interface through which outbound data is transmitted. This decision is based upon a variety of metrics including: Interface availability; Time of day; Type of service required; Interface priority and others. Examples of various routing metric schemes are presented later.

The TCP/IP Socket Interface 224 supports an Application Programming Interface (API) which, for example, conforms to the standard Berkley sockets paradigm. Its purpose is to shield the Application Layer from the details of the underlying networking protocols. It allows different network implementations to be employed without the applications being required to adapt.

The TCP/IP Router/Gateway 226 implements standard IP host support with the additional capability of being able to act as a gateway between multiple networks. IP datagrams received by this layer that are not destined for a local IP host address are forwarded through the network interface that is currently designated as the preferred route for the given destination address. It is possible that the management and selection of preferred routes is implemented by the Routing Decision Module 220 in the Application layer.

The PPP Protocol Driver 228 provides a network interface whose data-link protocol conforms to the Point-To-Point protocol standard. The SLIP Protocol Driver 230 provides a network interface whose data-link protocol conforms to the Serial-Line Internet Protocol de facto standard. Other protocol drivers 230 may be implemented which provide Network Interfaces which support either existing protocols or future protocols. The intent is to convey that the underlying link-layer protocol is transparent to the upper and lower layers and that additional protocols may be easily supported.

The MDC Interface Driver 234 provides device-specific support for Mobile Data Controller 54, as described above. The CDPD Interface Driver 236 provides device-specific support for a Cellular Digital Packet Data controller. Other device-specific drivers, e.g., Modem “X” Interface Driver 238 may be implemented to support current or future devices.

The Serial Port Driver 240 deals with the hardware aspects of asynchronous serial data communications such as manipulating a Serial I/O controller or other such external interface. Other physical layer drivers 242 may be implemented which support different external interface devices either existing or in the future.

For example, the router of the present invention may be included as an internal component of the mobile device, proving for an integrated mobile device. Optionally, the router may be implemented entirely as a software process running on, for example, a portable personal computer. In such an implemention, the internal slot(s) of the personal computer may be provided with network interface(s) and a software program may serve as the router core. Further, data may be routed to the different networks at another level than at the packet level. For example, entire messages may be routed over various networks if such a configuration is required.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims. For example, although the embodiments described above generally refer to routing over wireless networks from the Mobile Router 200, the present invention also operates when sending data from the Host Network Server 20. In this case, the Host Network Server 20 determines network availability based on information received from the Mobile Routers 200, in contrast to when the Mobile Router 200 is routing data and determining network availability for itself.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet-switched network transmission (e.g., TCP/IP, UDP/IP); and peripheral control (IrDA; RS232C; USB; ISA; ExCA; PCMCIA) represent examples of the state of the art. Such standards are periodically superseded by faster or more efficient equivalents having essentially the same functions. Accordingly, replacement standards and protocols having the same functions are considered equivalents.

What is claimed:

1. A method for routing data over multiple wireless networks; the data being received from a plurality of applications, the method comprising:
ascertaining availability of the multiple wireless networks;
receiving data from a selected application of the plurality of applications;
selecting a preferred wireless network based upon the type of received data;
sending the received data over the preferred wireless network when the preferred wireless network has been ascertained to be available; and
switching from a first wireless network to a second wireless network while sending data so that data is transmitted over both the first and the second wireless networks,
wherein the applications are unaware of the networks used for sending the data.

2. The method of claim 1, in which the type of received data indicates the application sending the data.

3. The method of claim 1, further comprising associating wireless networks with applications.

4. A method for routing data over multiple wireless networks, the data being received from a plurality of applications, the method comprising:
associating wireless networks with applications;
ascertaining availability of the multiple wireless networks;
receiving data from a selected application of the plurality of applications;
sending the received data over a wireless network associated with the selected application when the associated wireless network has been ascertained to be available; and
switching from a first wireless network to a second wireless network while sending data so that data is transmitted over both the first and the second wireless networks,
wherein the applications are unaware of the networks used for sending the data.

5. A computer readable medium storing a program for routing data over multiple wireless networks, the data being received from a plurality of applications, the medium comprising:
an availability code segment that ascertains availability of the multiple wireless networks;
a receiving code segment that receives data from a selected application of the plurality of applications;
a network selecting code segment that determines a preferred wireless network based upon the type of received data;
a sending code segment that sends the received data over the preferred wireless network when the preferred wireless network has been ascertained to be available; and
a switching code segment that switches from a first wireless network to a second wireless network while sending data so that data is transmitted over both the first and the second wireless networks,
wherein the applications are unaware of the networks used for sending the data.

6. The medium of claim 5, in which the type of received data indicates the application sending the data.

7. The medium of claim 5, further comprising a table associating wireless networks with applications.

8. A computer readable medium storing a program for routing data over multiple wireless networks, the data being received from a plurality of applications, the medium comprising:
a table associating each of the wireless networks with an application;
an availability code segment that ascertains availability of the wireless networks;
a receiving code segment that receives data from a selected application of the plurality of applications;
a sending code segment that sends the received data over a wireless network associated with the selected application when the associated wireless network has been ascertained to be available; and
a switching code segment that switches from a first wireless network to a second wireless network while sending data so that data is transmitted over both the first and the second wireless networks,
wherein the applications are unaware of the networks used for sending the data.

9. An apparatus for routing data over multiple wireless networks, the data being received from a plurality of applications, the apparatus comprising:
an network monitor that ascertains availability of the multiple wireless networks;
a receiver that receives data from a selected application of the plurality of applications;
a router that determining a preferred wireless network based upon the type of received data;
a transmitter that sends the received data over the preferred wireless network when the preferred wireless network has been ascertained to be available; and
a switch that switches from a first wireless network to a second wireless network while sending data so that data is transmitted over both the first and the second wireless networks,
wherein the applications are unaware of the networks used for sending the data.

10. The apparatus of claim 9, in which the type of received data indicates the application sending the data.

11. The apparatus of claim 9, further comprising a table associating wireless networks with applications.

12. An apparatus for routing data over multiple wireless networks, the data being received from a plurality of applications, the apparatus comprising:
a monitor that ascertains availability of the multiple wireless networks;
a receiver that receives data from a selected application of the plurality of applications;
a network selector that determines a preferred wireless network based upon the type of received data;
a transmitter that sends the received data over the preferred wireless network when the preferred wireless network has been ascertained to be available; and
a switch that switches from a first wireless network to a second wireless network while sending data so that data is transmitted over both the first and the second wireless networks,
wherein the applications are unaware of the networks used for sending the data.
